(19) United States
(12) Patent Application Publication
(10) Pub. No.: US 2003/0154185 A1
(43) Pub. Date: Aug. 14, 2003

(54) File creation and display method, file creation method, file display method, file structure and program

(76) Inventors: Akira Suzuki, Kanagawa (JP); Masami Koide, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/338,835

(22) Filed: Jan. 9, 2003

(30) Foreign Application Priority Data
Jan. 10, 2002 (JP) 2002-003356

(51) Int. Cl. G06F 7/00

(52) U.S. Cl. 707/1

(57) ABSTRACT

In a file structure, it is possible to properly assist a user of a computer to operate a file without the use of an extension of the file and overcome some problems caused by the difference of the development time between an operating system and application programs in the computer. In the file structure, a file comprises file content information formed of a program code or data processed by the computer and a management program code performing processes for assisting the user to operate the file corresponding to the file content information. Unlike conventional file creation and display methods depending on the extension, it is possible to properly aid user's file operations such as a file selection by calling the management program code from the operating system. Since the management program code is called based on an interface uniformly prescribed for all files in the computer, it is possible to apply the management program code to the files independently of the difference of the development time between the operating system and the application programs in the computer.

### BACKGROUND OF THE INVENTION

1. Field of the Invention

The present invention generally relates to a file creation and display method, a file creation method, a file display method, a file structure and a program.

2. Description of the Related Art

In general, a Neumann computer processes input data in accordance with a program and outputs a process result. A current ordinary computer maintains data and programs as a “file” in a secondary storage apparatus such as a hard disk device. In the computer, a central processing unit (CPU) reads a file from the secondary storage apparatus to a primary storage apparatus such as a main memory if necessary and performs an information process in accordance with data and programs in the read file. Under this configuration, the computer maintains a plurality of program files and a plurality of data files in the secondary storage apparatus, and an operator chooses a necessary file from the program files and the data files according to the purpose of the operator and causes the computer to perform an information process.

Under the above-mentioned foundation on the information process using a computer, an operation on a file selection is outlined under consideration of a history of development of file management methods. The recent improvement of an operating system (OS) has made it possible for a user to easily select a file. In a file management method performed by such an operating system, a file is identified by a “file name” together with an “extension” and is provided in a directory structure constructed as a virtual hierarchical structure. A user can allot a file name to an individual file in order to identify the file. Additionally, the user can attach an extension to the file name in order to distinguish the type of the file. As mentioned above, a file in a current computer has a file name as file identification information in the form “XXXX.YYY”, where XXXX is a file name and YYY is an extension. The secondary storage apparatus is virtually structured as a hierarchy so as to organize files in a computer system in accordance with classification of the files. In a conventional computer system, such a directory structure is commonly incorporated so that a user can consider the files to be hierarchically maintained.

Also, recent operating systems that adopts GUI (Graphical User Interface) can identify the type of a, file based upon the extension of the file and display a figure corresponding to the type, which is called an “icon”, together with the file name. In an application program to process information, the icon visually associated with the application program is displayed together with the name of the application program. Moreover, when the application program creates a file, an extension is attached to the file so as to recognize that the file is created by using the application program. As a result, the operating system can display the icon for representing the file created by the application program.

In conventional operating systems, the type of a file is identified by means of an extension, and an icon corresponding to the type is displayed so that a user can visually associate the file type. Then, the user can select a file based upon the icon and the file name that are displayed. Furthermore, the operating systems assist the user to select the file by displaying auxiliary information such as creation date and time of the file.

However, in the above-mentioned method, the user may have difficulty when the user selects a desired file among a large number of files. Especially regarding a file such as still image information, moving image information and audio information, if the file does not have an appropriate name, it may be hard for the user to find the desired file.

To eliminate the above-mentioned difficulty, the recent operating systems read the content of an image file when a name list of files including the image file should be displayed, and displays the reduced image of the image file as a so-called “thumbnail”. Also, regarding a file created by using some application programs, the content of the file is read and is displayed in a reduced form.

However, if the operating systems cannot interpret the format of a file, it is impossible for the operating systems to provide a file preview such as the thumbnail in the above-mentioned display method. The operating systems have the constraint that the operating systems can display the thumbnail of only the file created by means of the application program having the above-mentioned function. Thus, if an operating system in use is developed earlier than the application program, the operating system cannot display the thumbnail of a file created by using the application program.

Japanese Laid-Open Patent Application No. 05-241808 discloses an example in which a storage position of an icon pattern, the corresponding menu data, an editing tool, and a data file are stored as a file definition information registration means in advance, and an operating system works in accordance with the icon selected by a user. In this example, the icon is associated with an application program in advance so that the user can simply designate the application program by the icon.

However, this method only shows how to start the application program corresponding to an extension of a data file. In the method, the user has to set the relation between the extension and the application programs.

Japanese Laid-Open Patent Application No. 2000-090282 discloses an example in which a portion of data in a file is visualized and the visualized portion is used as an icon in order to show a characteristic of the file. In this method, an application program is used to visualize the portion of data in the file. While the application program has to interpret a format of the file, the format that the application program can interpret is commonly determined by a provider of the application program. Since this provider does not always coincide with a provider of an operating system in use, it is impossible to apply the method to all files that the operating system manages. Also, if such a function is applied to only certain files, a user is forced to operate these files in a different way from the others. In this case, on the contrary, the function may be inconvenient to the user.

As mentioned above, although some file management methods for showing the content and the status of a file to a user are proposed, only a file having a format that the file management program can handle can be displayed as an icon. Also, since the file management program is commonly incorporated in the operating system, it follows that the file management program is developed earlier than the application program for creating the file. Thus, it is impossible for the file management program to handle a data file created by using the application program.

On the other hand, Japanese Laid-Open Patent Application No. 11-224322 discloses a technique in a different art field from the above-mentioned one. In this application, a file having an image display program in addition to image data is proposed. The application discloses the technique that makes it possible for a computer to display an image even if an application program for displaying the image is not installed in the computer.

However, the technique includes an image display program (application program) serving to view the content of a file rather than to assist the user of the computer to perform a file own operation such as a file selection, a file rewriting and a file saving. In the technique, when the user would like to make sure the content of the file, the user additionally has to start the image display program.

In the technique, all operating systems are not provided with a unified interface. The technique just simplifies to display an image and does not serve to assist the user's file own operation when the user selects a certain file among a plurality of files and instructs a file operation.

As mentioned above, there is a rapid improvement of the performance of computers in recent years. The demand of a plenty of graphical functions in an interface of the computers typically motivates the performance improvement. An operating system incorporating GUI is usually installed in a personal computer at present. This type of operating system requires more computer resources than a character-based operating system because of the graphical display and process of information. Therefore, a computer using such a type of operating system is required to have processing power beyond necessary power for inherent computation. In other words, the enhancement of the user interface is important to the current computer.

Also, when a computer has more opportunities to deal with multimedia through the Internet as seen in present situations, the computer is required to perform more processes. At present, computers with sufficient processing power for processing the GUI are provided.

Meanwhile, in a normal use of a prevailing computer, when a user starts an application program or selects a data file, the user has to find out a file that the user wants among a plurality of files. When an unfamiliar user searches for the file by using the file name and the extension as search keys, the user may feel the search as heavy burdens. Thus, the display of a figure, so-called an icon, assists the user to select the file. However, while the icon serves to visually display the type of the file, the icon cannot express the content and the status of the file.

As mentioned above, some approaches are presented to overcome the above problems. However, these approaches totally depend on a file management program of an operating system for managing files. Also, various application programs are provided by a plurality of distinct manufacturers. If an application program and a file management file are not produced by an identical manufacturer, the approaches cannot successfully work. Additionally, the approaches cannot successfully work for files created by using the application program.

In a conventional file management method depending on the file name and the extension, the extension is registered in the file management program for each file management program. Then, based upon the registered extension, an icon is displayed and an application program associated with a data file is executed. As a result, it is necessary to uniquely relate an application program to an extension.

In the conventional methods where the display of an icon and a thumbnail for assisting a user to operate a file depends on an extension, there are some problems as follows.

First, since an icon of a file is displayed based upon an extension, an icon indicating an application program used to create a data file is not always displayed if the data file is a standard data file having a fixed extension such as an image file and an HTML file. (A user is not allowed to freely change an extension. Although it is not preferable that distinct application programs create data files whose extensions are identical, there are actually some cases in which the identical extension is provided to an image file format and an HTML document.)

Second, alternation of an extension entails changing an icon. For instance, when an extension of an image file is changed into that of text file, the icon of the changed image file is also changed into that of text file and an unsuitable application program is executed.

Third, an icon cannot be displayed until an extension is registered.

Fourth, when a data file is displayed as a thumbnail, a file management program (file name display program) serving to display a thumbnail cannot display the thumbnail unless a data file format for the data file is publicized at the time of the development of the file management program.

### SUMMARY OF THE INVENTION

It is a general object of the present invention to provide a file creation and display method, a file creation method, a file display method, a file structure and a program in which the above-mentioned problems are eliminated.

A more specific object of the present invention is to provide a novel method that can properly assist a user of a computer to operate a file in the computer in a new file structure without depending on the extension of the file and be applicable to both a program pertaining to the operating system of the computer and a program pertaining to an application program installed in the computer regardless of the difference of the development time between the operating system and the application program.

In order to achieve the above-mentioned objects, there is provided according to one aspect of the present invention a file creation and display method, comprising the steps of: receiving an instruction to save file content information formed of a program code or data that a computer executes or processes; obtaining a management program code prepared in advance by a provider of an application program for processing the file content information, wherein the management program code is called by a program pertaining to an operating system of the computer based on an interface uniformly prescribed for all files in the computer and performs a process for assisting a user of the computer to operate a file in the computer in accordance with file content information of the file; storing the file content information and the management program code as a file in a storage apparatus; causing the program pertaining to the operating system to call the management program code of a file to be processed based on the interface uniformly prescribed; and performing the process for assisting the user of the computer to operate the file in the computer by executing the management program code called by the program pertaining to the operating system.

According to the above-mentioned invention, when a computer system adopts the file structure in which a file integrally has not only file content information containing substantial information of the file but also a management program code to perform a process for assisting the user to operate the file in accordance with the content type of the file content information, the computer system can properly assist the user's file operation such as the file selection and the file own operation by executing the management program code unlike conventional file creation and display methods depending on the extension of file. Since the management program code is called by a program pertaining to the operating system of the computer system based on the interface uniformly prescribed for all files in the computer system, the file creation and display method is applicable independently of the difference of the development time between the operating system and application programs in the computer system. Thus, when the file structure is used in the computer system, it is possible to provide the file creation and display method that can achieve high generality and easily create a file having the novel file structure.

Further, there is provided according to another aspect of the present invention a file creation method, comprising the steps of: receiving a saving instruction to save file content information formed of a program code or data that a computer executes or processes; obtaining a management program code prepared in advance by a provider of an application program for processing the file content information, wherein the management program code is called by a program pertaining to an operating system of the computer based on an interface uniformly prescribed for all files in the computer and performs a process for assisting a user of the computer to operate a file in the computer in accordance with file content information of the file; and storing the file content information and the management program code as a file in a storage apparatus.

According to the above-mentioned invention, it is possible to simply create a file having the file structure integrally containing the file content information and the management program code to perform the process for assisting the user to operate a file.

Further, there is provided according to another aspect of the present invention a file display method, comprising the steps of: causing a program pertaining to an operating system of a computer to call a management program code of a file to be processed based on an interface uniformly prescribed for all files in the computer, wherein the file stored in a storage apparatus comprises file content information formed of a program code or data that the computer executes or processes and the management program code, and the management program code is prepared in advance by a provider of an application program for processing the file content information and performs a process for assisting a user of the computer to operate a file in the computer in accordance with file content information of the file; and performing the process for assisting the user of the computer to operate the file in the computer based on the management program code called by the program pertaining to the operating system.

According to the above-mentioned invention, when a computer system adopts the file structure in which a file integrally has not only file content information containing substantial information of the file but also a management program code to perform a process for assisting a user to operate the file in accordance with the content type of the file content information, the computer system can properly assist the user's file operation such as the file selection and the file own operation by executing the management program code unlike conventional file display methods depending on the extension of file. Since the management program code is called by a program pertaining to the operating system of the computer system based on the interface uniformly prescribed for all files in the computer system, the file display method is applicable independently of the difference of the development time between the operating system and application programs in the computer system. Thus, when the file structure is used in the computer system, it is possible to provide the file display method that can achieve high generality and simply create a file having the novel file structure.

Further, there is provided according to another aspect of the, present invention a file structure of a file, comprising: file content information formed of a program code or data that a computer executes or processes; and a management program code, which is prepared in advance by a provider of an application program for processing the file content information, called by a program pertaining to an operating system of the computer based on an interface uniformly prescribed for all files in the computer and performing a process for assisting a user of the computer to operate a file in the computer in accordance with file content information of the file.

According to the above-mentioned invention, when a computer system adopts the file structure in which a file integrally has not only file content information containing substantial information of the file but also a management program code to perform a process for assisting a user to operate the file in accordance with the content type of the file content information, the computer system can properly assist the user's file operation such as the file selection and the file own operation by executing the management program code unlike conventional file structures depending on the extension of file. Since the management program code is called by a program pertaining to the operating system of the computer system based on the interface uniformly prescribed for all files in the computer system, the file structure is applicable independently of the difference of the development time between the operating system and application programs in the computer system. Thus, it is possible to provide the file structure that can achieve high generality and simply create a file having the novel file structure.

In the above-mentioned file structure, the file structure may further comprise a file header containing information indicating that the file has a management program code.

According to the above-mentioned invention, even if the computer system has both a file having the file structure having the management program code and a file having a conventional file structure without the management program code therein, it is possible to perform a proper process by distinguishing between the two types of file by means of the file header.

In the above-mentioned file structure, the management program code may perform the process for assisting the user of the computer to operate a file in the computer before the user instructs the computer to execute a program code of file content information of the file or to read data of file content information of the file.

According to the above-mentioned invention, since the management program code performs the process for assisting the user of the computer to operate a file in the computer before the user's instruction to execute a program code of file content information of the file or to read data of file content information of the file, it is possible to grasp the file content information in advance and perform the process for assisting the user's file operation such as the file selection and the file own operation unlike a file having a conventional file structure integrally including the application program.

In the above-mentioned file structure, the management program code may be described as an intermediate language code. According to the above-mentioned invention, since the management program code is described as an intermediate language code, it is possible to execute the management program code of the file even in a computer mounting a different type of CPU.

In the above-mentioned file structure, the management program code may perform only a certain function allowed by the computer as the process for assisting the user of the computer to operate a file in the computer.

According to the above-mentioned invention, since the management program code performs only a certain function allowed by the computer, it is possible to prevent the execution of the management program code when the management program code incorporates a harmful program such as a computer virus. Also, since the management program file serves to assist the user's file operation and is not often expected to have functions other than the function to just explain the file contents, the function restriction does not matter in the practical use of the computer.

In the above-mentioned file structure, a point of time when a program pertaining to the operating system starts the management program code of the file may be set.

According to the above-mentioned invention, it is possible to cause the management program code to perform a different process in accordance with the status of the operating system when the operating system calls the management program code. Thus, it is possible to avoid imposing unnecessary burdens on the computer caused by execution of the management program code for every event and provide the computer system that can more flexibly operate.

In the above-mentioned file structure, the management program code may have an environment information obtaining part obtaining environment information of the computer and perform the process for assisting the user of the computer to operate a file in the computer with reference to the environment information obtained.

According to the above-mentioned invention, it is possible to alter the operation performed by the management program code in accordance with the connection status of input and output apparatuses connected to the computer. Thus, the management program code can respond more flexibly.

In the above-mentioned file structure, the environment information of the computer may be created based on an information item registered in advance in the computer.

According to the above-mentioned invention, when the environment information of the computer is registered in advance in the computer, the management program code can obtain the environment information and respond properly even if the management program code is designed later than the operating system.

In the above-mentioned file structure, the management program code may determine whether or not the file content information of the file is available and cause the computer to display a determination result of the availability of the file content information.

According to the above-mentioned invention, since the computer displays the availability of the file content information based on the obtained environment information, the user can determine whether or not to reproduce the file in advance and properly determine whether or not to select the file.

In the above-mentioned file structure, the management program code may have information, which is registered in advance in the computer, regarding a disability of the user of the computer as the environment information obtained and perform a process corresponding to the information regarding the disability of the user of the computer as the process for assisting the user of the computer to operate a file in the computer.

According to the above-mentioned invention, if the information regarding the disability of the user as the environment information is obtained, it is possible to perform the process for assisting the user to operate the file, for instance, the process for displaying an icon in the large size corresponding to the disability.

In the above-mentioned file structure, the management program code may further perform a process for causing the computer to display outline information of file content information as the process for assisting the user of the computer to operate a file in the computer.

According to the above-mentioned invention, when the computer displays the outline information of file content information as the process for assisting the user of the computer to operate a file in the computer, the user can properly operate the file. Also, when the file maintains the management program code for displaying the outline information, it is unnecessary to take into consideration the difference of the development time between a program pertaining to the operating system such as the file name display program and the file format related to the file structure according to the above-mentioned invention.

In the above-mentioned file structure, the management program code, when the file content information is audio information, may perform a process for causing the computer to reproduce at least a portion of the audio information as the process for assisting the user of the computer to operate a file in the computer.

According to the above-mentioned invention, when at least a portion of the audio information is reproduced as the process for assisting the user of the computer to operate a file in the computer, the user can grasp the outline of the audio file without starting the application program for reproducing the audio file and properly select the file.

In the above-mentioned file structure, the management program code, when the file content information is still image information, may perform a process for causing the computer to display one of at least a portion of the still image information and a reduced image of the still image information as the process for assisting the user of the computer to operate a file in the computer.

According to the above-mentioned invention, when at least a portion or a reduced image of the still image information is displayed as so-called a thumbnail image, the user can properly select the desired file.

In the above-mentioned file structure, the management program code, when the file content information is moving image information, may perform a process for causing the computer to reproduce at least a portion of the moving image information as the process for assisting the user of the computer to operate a file in the computer.

According to the above-mentioned invention, when at least a portion of the moving image information is reproduced as a series of flash images, the user can properly find the desired moving image in a plurality of moving image files.

In the above-mentioned file structure, the management program code may perform a process different between file list exhibition time when a list of files is displayed and file selection time when a file is selected as the process for assisting the user of the computer to operate a file in the computer.

According to the above-mentioned invention, although the information display area has a different size between the file list exhibition time and the file selection time, it is possible to provide the display suitable for each of the file list exhibition time and the file selection time by performing the process different between file list exhibition time and the file selection time.

In the above-mentioned file structure, the management program code may determine whether or not a file own operation is executable for the file and perform a process for causing the computer to display a result of the determination as the process for assisting the user of the computer to operate a file in the computer.

According to the above-mentioned invention, when the availability of the file own operation such as “copy”, “delete” and “move” of the file is displayed in advance, the user can avoid performing an improper file own operation.

In the above-mentioned file structure, the file content information may contain address information and exhibition image information of a Web page and the management program code may perform a process for causing the computer to display outline exhibition image information for showing an outline of the Web page as the process for assisting the user of the computer to operate a file in the computer.

According to the above-mentioned invention, since the outline exhibition image information for so-called a bookmarked file is also maintained and displayed, the user can find the desired address more easily than when only the address information is displayed.

In the above-mentioned file structure, the management program code, when a Web page is displayed, may search for a file whose file content information contains address information identical to the Web page and update outline exhibition image information for showing an outline of a Web page of the file when the file is found.

According to the above-mentioned invention, it is possible to update the outline exhibition image information of the bookmarked file in response to the update of the Web page. The user can search for the desired file based on the up-to-date view of the Web page.

In the above-mentioned file structure, the management program code, when the file content information is a program code of an application program for displaying or editing a file having a predetermined data format, may perform a process for causing the computer to display history list information of the file displayed or edited before by the application program in accordance with an instruction to select the file by the user as the process for assisting the user of the computer to operate a file in the computer.

According to the above-mentioned invention, when the computer displays the history list information of files displayed or edited before, the user can easily find and select the desired file displayed or edited before using the application program by simply selecting the file of the application program.

In the above-mentioned file structure, the management program code, when the user of the computer selects a file among files that have the predetermined data format and are in the history list information displayed by the computer, may perform a process for causing the application program to read the file selected and start as the process for assisting the user of the computer to operate a file in the computer.

According to the above-mentioned invention, it is possible to start the application program corresponding to the selected file smoothly and improve the operability of the file operation.

In order to achieve the above-mentioned objects, there is provided according to another aspect of the present invention a program for causing a computer to execute the steps of: receiving an instruction to save file content information formed of a program code or data that the computer executes or processes; obtaining a management program code prepared in advance by a provider of an application program for processing the file content information, wherein the management program code is called by a program pertaining to an operating system of the computer based on an interface uniformly prescribed for all files in the computer and performs a process for assisting a user of the computer to operate a file in the computer in accordance with file content information of the file; and storing the file content information and the management program code as a file in a storage apparatus.

According to the above-mentioned invention, it is possible to easily create a file having the file structure integrally containing the file content information and the management program code to perform the process for assisting the user to operate a file.

In the above-mentioned program, the step of receiving the instruction to save the file content information may be a step of receiving an instruction to create outline exhibition image information showing an outline of a Web page and the file content information may be formed of the outline exhibition image information and address information of the Web page.

According to the above-mentioned invention, when a file integrally having the file content information and the management program code to perform the process for assisting the user's file operation is created, it is possible to easily create a file that can display not only the address information of the Web page but also the outline exhibition image information.

In the above-mentioned program, the program may further cause the computer to execute the steps of: searching for, when a Web page is displayed, a file whose file content information contains address information identical to the Web page; and updating outline exhibition image information for showing an outline of a Web page of the file when the file is found.

According to the above-mentioned invention, the outline exhibition image information of the Web page can be updated and recreated for the file that can display the outline exhibition image information at an appropriate time or in an appropriate interval of time. As a result, it is possible to correspond to the up-to-date status of the Web page.

In order to achieve the above-mentioned objects, there is provided according to another aspect of the present invention a program for causing a computer to execute: preprocessing step of calling a management program code of a file to be processed based on an interface uniformly prescribed for all files in the computer, wherein the file stored in a storage apparatus comprises file content information formed of a program code or data that the computer executes or processes and the management program code, and the management program code is prepared in advance by a provider of an application program for processing the file content information and performs a process for assisting a user of the computer to operate a file in the computer in accordance with file content information of the file and outputting information regarding an operation performed by the user; and postprocessing step of receiving the information regarding the operation performed by the user from the management program code of the file via the interface and performing a process based on the information.

According to the above-mentioned invention, it is possible to provide a program pertaining to the operating system that can correspond to a file having the file structure containing the management program code to perform the process for assisting the user's file operation.

In the above-mentioned program, the program may further cause the computer to execute the step of: starting an intermediate language code processing function when the management program code is described as an intermediate language code.

According to the above-mentioned invention, since the management program code is described as an intermediate language code, it is possible to execute the management program code of the file even in a computer mounting a different type of CPU by using an interpreter.

In the above-mentioned program, the program may further cause the computer to execute the step of: restricting any execution of functions other than a certain function of the management program code.

According to the above-mentioned invention, it is possible to prevent the execution of the management program code when the management program code incorporates a harmful program such as a computer virus.

In the above-mentioned program, the program may further cause the computer to execute the step of: outputting, when a request to obtain environment information of the computer is received from the management program code, the environment information to the management program code via the interface.

According to the above-mentioned invention, it is possible to properly perform the process by delivering the environment information of the computer to the management program code.

In the above-mentioned program, the program may further cause the computer to execute the step of: maintaining in advance an environment item to respond to the request to obtain the environment information of the computer.

According to the above-mentioned invention, it is possible for the management program code to properly correspond by registering the environment item of the computer in advance even if the management program code is developed later than the operating system.

In the above-mentioned program, the postprocessing step, when information regarding a determination result of availability of the file content information of the file is received from the management program code, may cause the computer to display information regarding the availability.

According to the above-mentioned invention, the user can determinate a file operation with reference to the information regarding the availability of the file content information of the file before the file is selected or read.

In the above-mentioned program, the program may further cause the computer to execute the step of: outputting, when a request to obtain information regarding a disability of the user is received from the management program code, the information regarding the disability registered in advance in the computer to the management program code via the interface.

According to the above-mentioned invention, since the information regarding the disability of the user is provided to the management program code, the user can comfortably perform a file operation in the computer.

In the above-mentioned program, the postprocessing step, when information regarding availability of a file own operation is received from the management program code, may cause the computer to display the information regarding the availability of the file own operation.

According to the above-mentioned invention, since the user can confirm the availability of the file operation, the user can properly perform the file operation.

In the above-mentioned program, the postprocessing step, when the operation performed by the user is an instruction to read a file, may inform a creator of the file that the file is read via a network based on the information from the management program code.

According to the above-mentioned invention, for instance, when the file creator can be informed that the audio information of the file is reproduced, it is possible to develop a more proper copyright management system and billing system.

In the above-mentioned program, the postprocessing step, when outline information of the file content information is received from the management program code, may cause the computer to display the outline information.

According to the above-mentioned invention, when the outline information of the file content information is received from the management program code, the user can select a proper file by displaying the outline information.

In the above-mentioned program, the postprocessing step, when at least a portion of audio information of the file content information is received from the management program code, may reproduce the portion of the audio information.

According to the above-mentioned invention, when at least a portion of the audio information is reproduced as the process for assisting the user of the computer to operate a file in the computer, the user can grasp the outline of the audio file without starting the application program for reproducing the audio file and properly select the file.

In the above-mentioned program, the postprocessing step, when at least a portion of still image information or a reduced image of the still image information is received from the management program code, may cause the computer to display the portion of the still image information or the reduced image of the still image information.

According to the above-mentioned invention, when at least a portion or a reduced image of the still image information is displayed as so-called a thumbnail image, the user can properly select the desired file.

In the above-mentioned program, the postprocessing step, when at least a portion of moving image information of the file content information is received from the management program code, may reproduce the portion of the moving image information.

According to the above-mentioned invention, when at least a portion of the moving image information is reproduced as a series of flash images, the user can properly find the desired moving image in a plurality of moving image files.

In the above-mentioned program, the postprocessing step may cause the computer to display history list information of the file when the file content information of the file is a program code of an application program displaying or editing a file having a predetermined data format and information regarding a file displayed or edited before by the application program is received from the management program code of the file.

According to the above-mentioned invention, when the file content information is a program code, the user can receive the information of the file displayed or edited before by using the program from the management program code of the file only by selecting the file of the application program. As a result, the user can observe the history list of files displayed or edited before and select the desired file more smoothly.

In the above-mentioned program, the preprocessing step may output the information regarding the operation performed by the user to management program codes of a plurality of files in the computer and the postprocessing step may receive the information from the management program codes of the files and performs a process when the operation performed by the user is an instruction to display a list of files.

According to the above-mentioned invention, it is possible to perform the display process for assisting the user's file operation in the list of files by using the management program code in the file.

Other objects, features and advantages of the present invention will become more apparent from the following detailed description when read in conjunction with the accompanying drawings.

### BRIEF DESCRIPTION OF THE DRAWINGS

FIG. 1 shows a hardware configuration of a computer according to an embodiment of the present invention;

FIG. 2 is a schematic diagram illustrating an example of a file operation that is performed in general in such a computer system as shown in FIG. 1;

FIG. 3 is a diagram illustrating an example of file storage that is used in general in such a computer system as shown in FIG. 1;

FIG. 4 is a diagram illustrating a display example of file identification information that is provided to a user in general in such a computer system as shown in FIG. 1;

FIG. 5 is a diagram illustrating an example of a hierarchical structure that is used in general to virtually store files in such a computer system as shown in FIG. 1;

FIG. 6 is a flowchart illustrating a procedure of a file name display program that is used in general in such a computer system as shown in FIG. 1;

FIG. 7 is a diagram illustrating a display example of a list of file names produced by the file name display program that is used in general in such a computer system as shown in FIG. 1;

FIG. 8 is a flowchart illustrating a procedure of another file name display program that is used in general in such a computer system as shown in FIG. 1;

FIG. 9 is a diagram illustrating an example of a file structure according to the embodiment of the present invention;

FIG. 10 is a diagram illustrating another example of a file structure according to the embodiment of the present invention;

FIG. 11 is a detailed diagram illustrating an example of the file structure in FIG. 10;

FIG. 12 is a detailed diagram illustrating another example of the file structure in FIG. 10;

FIG. 13 is a diagram illustrating an example of FTYPE codes maintained in FTYPE information in the file structure according to the embodiment;

FIG. 14 is a diagram illustrating an example of an interface for calling a management program code;

FIG. 15 is a flowchart of a procedure performed by an operating system and the management program code;

FIG. 16 is a diagram illustrating an example of a data structure of Q_List;

FIG. 17 shows a table representing correspondence between codes and types of environment information to be obtained;

FIG. 18 is a diagram illustrating an example of a data structure of A_List;

FIG. 19 is a diagram illustrating an example of a data structure of location information of a Question function and an Answer function;

FIG. 20 is a diagram illustrating another example of the data structure of the location information of the Question function and the Answer function;

FIG. 21 is a diagram illustrating an example of a file header if there are a plurality of program codes describing the management program code;

FIG. 22 is a flowchart of a procedure for controlling the program codes for the management program code in FIG. 21;

FIG. 23 is a diagram illustrating an example of a hierarchical structure that is used to virtually store files having the file structure according to the embodiment;

FIG. 24 is a diagram illustrating an example of file storage of files having the file structure according to the embodiment;

FIG. 25 is a block diagram schematically illustrating a role of the management program code;

FIG. 26 is a flowchart of a procedure for creating a file having the file structure according to the embodiment;

FIG. 27 is a diagram illustrating an example of a data structure of a Web page having the file structure according to the embodiment;

FIG. 28 is a flowchart of a procedure for creating a Web page having the file structure according to the embodiment;

FIG. 29 is a flowchart of a procedure for updating the Web page having the file structure according to the embodiment;

FIG. 30 a diagram schematically illustrating an example of a file operation for the Web page having the file structure according to the embodiment;

FIG. 31 is a flowchart of a procedure of the file name display program;

FIG. 32 is a diagram illustrating an example of a data structure of R_List;

FIG. 33 is a flowchart of a procedure of the Question function in a general case;

FIG. 34 is a flowchart of a procedure of the Answer function in a general case;

FIG. 35 is a flowchart of a procedure of the Question function when the file content information is still image information;

FIG. 36 is a flowchart of a procedure of the Answer function when the file content information is still image information;

FIG. 37 is a diagram illustrating a display example at file selection time;

FIG. 38 is a flowchart of a procedure of the Question function including a process for determining availability of a file having the file structure according to the embodiment;

FIG. 39 is a flowchart of a procedure of the Answer function including a process for determining availability of a file having the file structure according to the embodiment;

FIGS. 40A and 40B are diagrams illustrating a display example of availability of an audio file having the file structure according to the embodiment;

FIGS. 41A and 41B are diagrams illustrating a display example of availability of a program file having the file structure according to the embodiment;

FIGS. 42A through 42C are diagrams illustrating a display example of availability of a file own operation for a file having the file structure according to the embodiment;

FIG. 43A is a diagram illustrating a display example of a history list of files of an application program;

FIG. 43B is a diagram illustrating a display example of the history list of files of the application program when the user selects one of the files in the history list;

FIG. 44 is a flowchart of a procedure performed by the operating system and the management program code with respect to the history list;

FIG. 45 is a flowchart of a procedure performed by the operating system and the management program code with respect to the history list after the user selects the file; and

FIG. 46 is a flowchart of a procedure performed by the operating system and the management program code with respect to a notification process.

### DETAILED DESCRIPTION OF THE PREFERRED EMBODIMENTS

In the following, embodiments of the present invention will be described with reference to the accompanying drawings.

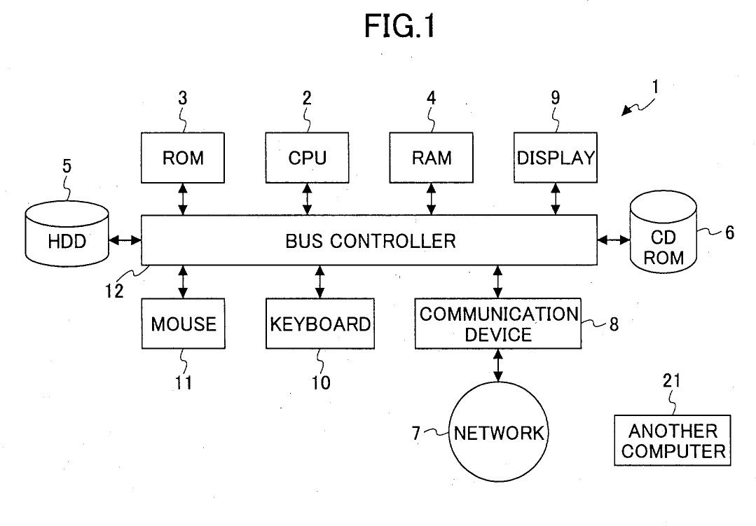

FIG. 1 shows a hardware configuration of a personal computer according to the embodiment of the present invention. A personal computer (hereinafter referred to as a computer) 1 comprises a CPU 2 processing information, a ROM 3 for storing some data such as BIOS (Basic Input Output System), a primary storage apparatus such as a RAM 4 for temporarily storing information during execution, a secondary storage apparatus such as a HDD (Hard Disk Drive) for storing some data such as an execution result, a drive of a removable media 6 such as a CD-ROM for storing/distributing information in/to an exterior of the computer 1 and obtaining information from an exterior of the computer 1, a communication device 8 for connecting to a network 7 so as to communicate with another computer 21 being in an exterior of the computer 1, a display 9 displaying an execution progress and an execution result to a user, and an input apparatus such as a keyboard 10 and a mouse 11 through which the user inputs an instruction and information to the computer 1. A bus controller 12 serves to arrange a data communication among these parts.

In such a computer 1, in general, when a user turns on power, the CPU 2 executes a loader program in the BIOS stored in the ROM 3 and reads an operating system serving to manage hardware and software of the computer 1 from the HDD 5. The operating system supports an application program to start, read and save information in accordance with an operation of the user after the start of the operating system. Windows (registered trademark of Microsoft Corporation) and UNIX (registered trademark of X/Open Inc.) are typical operating systems.

A description will now be given of a structure and an operation with respect to a file operation by using such a computer 1.

Through such an operating system, in general, a user operates digital information by a unit of information, so-called a “file”, which is stored for instance in the secondary storage such as the HDD 5, in order to start an application program and edit, save and delete data. When the user manipulates the computer 1 for various operations, all programs and data are treated as the files, which are stored for instance in a storage apparatus such as the HDD 5 and the CD-ROM 6.

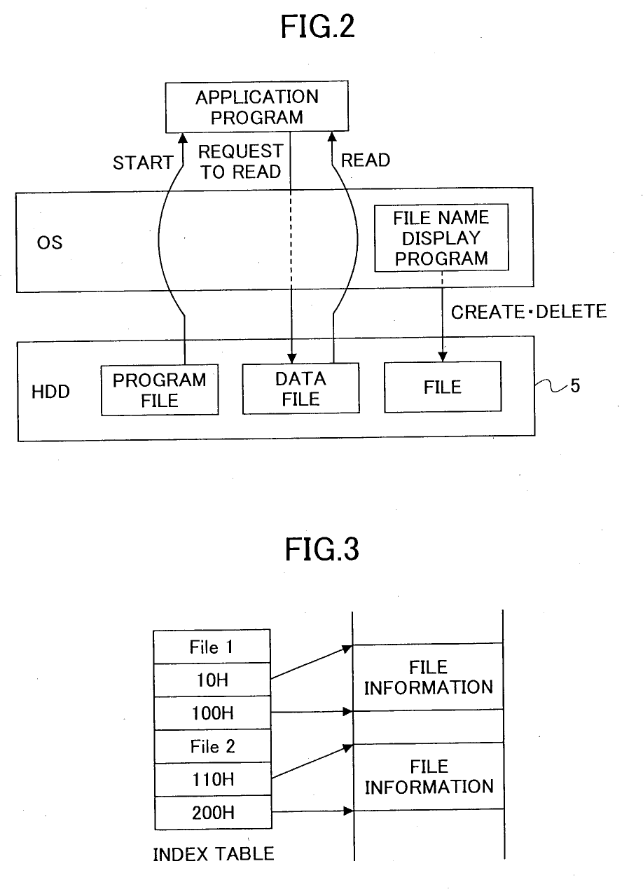

FIG. 2 shows an outline of the above-mentioned computer system. The operating system reads and executes a program file associated with an application program from the HDD 5 or the like in accordance with an instruction of a user. In addition, the operating system reads a data file in accordance with a request of the application program. Also, the operating system executes a file operation such as the creation and the deletion of a file in accordance with the user's instruction. As is to be mentioned later, concerning the embodiment of the present invention, it is supposed that a file name display program (file management program) is contained in the operating system. In the present invention, the operating system and the file name display program are integrated and called a “program pertaining to the operating system”. The file name display program serves to display, move, delete, copy and create a file.

Although operating systems use various methods for storing files in the storage apparatus such as the HDD 5, the files are generally stored as shown in FIG. 3. Namely, information, which is called an “index table”, is maintained in a certain location of the storage apparatus. File identification information such as a file name for identifying a file and information regarding a storage location of the file are registered in the index table. Here, the storage location information is typically formed of both the start position and the size of substantial information of the file (file content information) or both the start position and the end position of the file content information in the secondary storage apparatus. The operating system reads the index table to the primary storage apparatus RAM 4. When the operating system attempts to read a file, the operating system finds the file identification information corresponding to the file from the index table and obtains the storage location information of the file from the index table. In this fashion, the operating system can read the file from the secondary storage such as the HDD 5.

As the above fashion, the index table, which corresponds to contents of a book, is used to search for a file position quickly. Here, although an actual storage location is registered in the index table in this example, the operating system often refers to an allocation table in which the memory space is divided into a plurality of pages with a an appropriate size to obtain the file position in practical use. The allocation table maintains information indicating whether or not a page in the memory space contains information. The operating system finds an empty space with reference to the allocation table when the operating system attempts to store information. In this embodiment, such an arbitrary method may be used with respect to the memory space mapping method as long as the method is reasonable.

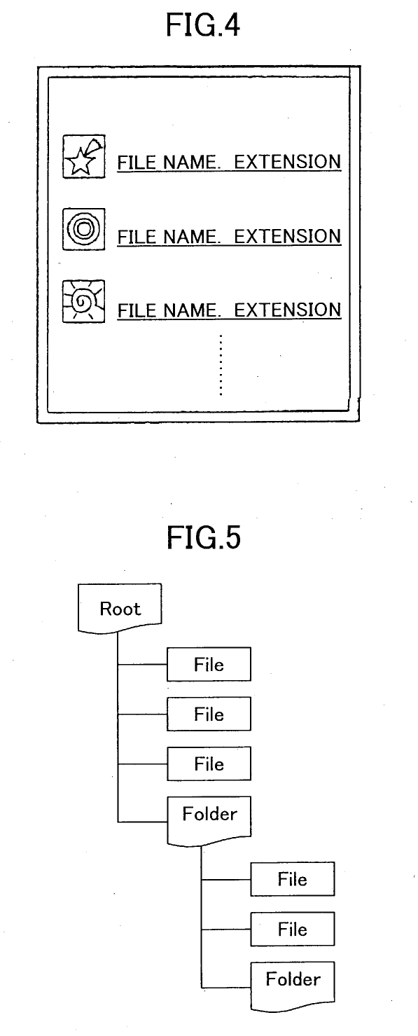

Also, a “file name” and an “extension” are often used as the above-mentioned file identification information. As is shown in FIG. 4, an individual file is referred to by a combination of the file name and the extension so that a user can easily distinguish files. Basically, when the user operates the computer 1, the user has to designate and determine the combination. In the typical operating system Windows (registered trademark of Microsoft Corporation), extensions “EXE” and “DLL” are attached to an executable program file and a library file in order to be separated from other types of file, respectively. Also, in a typical application program MS-Word (registered trademark of Microsoft Corporation) that is used in the Windows, an extension “DOC” is attached to a document file that is a data file created by the MS-Words. Additionally, as is shown in FIG. 4, a figure “icon”, which visually represents the type of a file, is displayed together with the file name and the extension of the file. Conventionally, an operating system has the file name display program for displaying the view as shown in FIG. 4 on the display 9.

A description will now be given of a conventional file name display program. As is shown in FIG. 5, the computer 1 maintains a file in the storage apparatus under a directory structure formed of a virtual hierarchical structure. Normally, there is a root folder in the top level of the directory structure and there are files or folders in the hierarchical levels below the root folder.

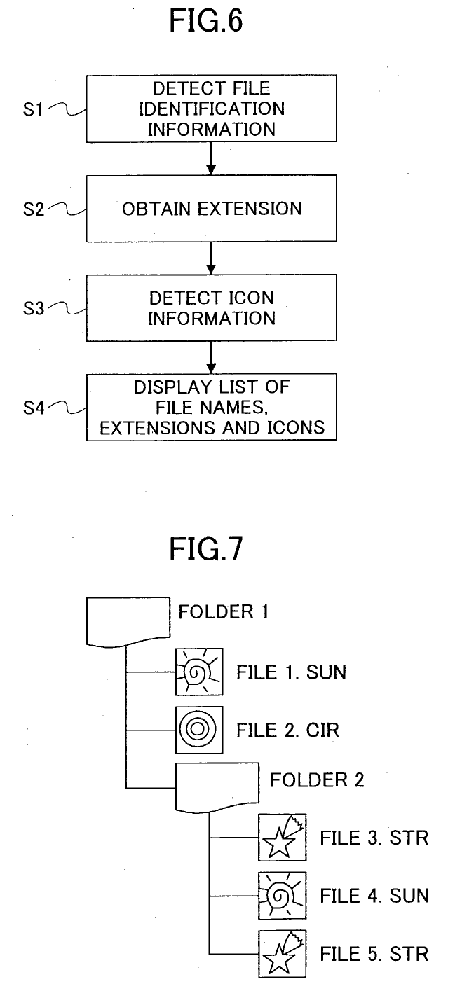

A user selects the desired file among a plurality of files managed in such a hierarchical structure and then instructs to execute or read the file. Here, the file name display program follows a procedure as shown in a flowchart in FIG. 6. At step S1, the file name display program detects file identification information of a file to be displayed. In fact, the file name display program searches for the combination of the file name and the extension of the file. At step S2, the file name display program detects the extension in the file identification information. At step S3, the file name display program detects information regarding an icon corresponding to the extension. Conventionally, the operating system is responsible to manage the icon information. The icon information corresponding to an individual extension is registered in the operating system and the icon information corresponding to the detected extension is notified to the file name display program. Here, if the file is an executable program file, the executable program file often holds an icon to be displayed. In this case, the icon held in the executable program file is notified to the file name display program prior to the registered icon. The above steps are performed for each of a plurality of files. At step S4, the file name display program displays a list of file names, extensions and icons on the display 9.

FIG. 7 shows the view of the list of file names, extensions and icons displayed by the file name display program in the procedure in FIG. 6. FIG. 7 illustrates an example of three extensions: “SUN”, “STR” and “CIR”. As mentioned above, the conventional file name display program finds an icon registered based upon an extension of a file or icon information held in the file to be displayed and then display the icon.

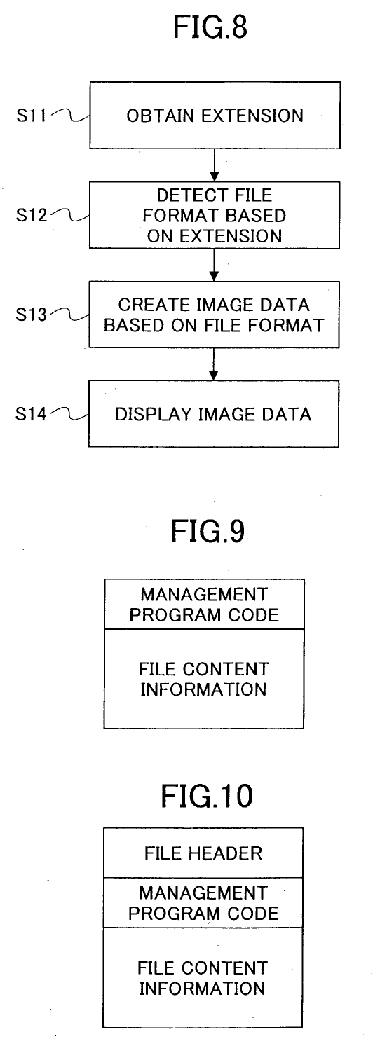

On the other hand, the file name display program may perform a procedure shown in a flowchart in FIG. 8. At step S11, the file name display program obtains an extension from the file identification information. At step S12, the file name display program detects a format of the file from the extension. At step S13, the file name display program interprets file content information of the file from the format and creates image data. At step S14, the file name display program displays the image data. The above method is often used for an image file and is conventionally called a “thumbnail display”. As the above fashion, the file name display program displays the list of file names and extensions as well as icons associated with the files or images representing the contents of the files. This icon display is totally based upon the file name and the extension, and the thumbnail display is also based upon the format determined from the extension. Thus, if the file name display program cannot understand the extension and the format, the file name display program cannot display the icon and the image corresponding to the file.

Regarding such a view as shown in FIG. 7, the file name display program, which serves to display the view, is conventionally developed and distributed together with an operating system. Therefore, if an application program is developed after the development of the operating system, it is necessary to register an icon corresponding to the application program at the installment of the application program to the computer. In order to deal with such a case, the correspondence of the icon with the extension of the application program is registered at the installment, and the application program is set to attach the extension to a data file created by using the application program. However, in the above method, although it is possible to display an icon for each application program, the thumbnail display cannot be provided to the user.

A file structure that can eliminate the above-mentioned problems and achieve a more successful file display than conventional methods is presented in this embodiment of the present invention. Additionally, a file name display program may be developed before an application program under this embodiment.

FIG. 9 shows an example of the file structure according to this embodiment. The file structure is characterized in that a “management program code” is additionally provided corresponding to the file information in FIG. 3. Also, a “file header” in addition to a “management program code” may be provided in a file structure as shown in FIG. 10. The file header is provided so as to distinguish between a file created under an operating system using a conventional file structure and a file having a management program code of the file structure according to this embodiment. If the operating system in use adopts the file structure according to the embodiment for all files in the computer, the file header is not necessary. Just when the file structure according to the embodiment is introduced, the computer temporarily has the two types of files. Therefore, the file header will be described with reference to an example of the file structure in FIG. 10.

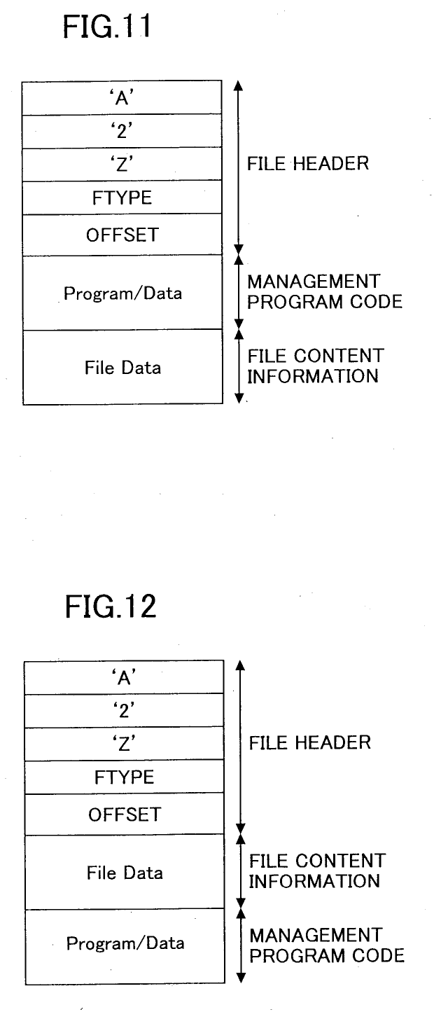

FIG. 11 shows the structure shown in FIG. 10 in detail. In FIG. 11, a file has a file header at the head of the file. A code to distinguish between the file formats is provided to the file header. The code may be an arbitrary type of code. In the embodiment, the code is represented by three ASCII codes “A”, “2” and “Z” using 3 bytes. An FTYPE code representing a detailed type of the file is followed by the code. In the embodiment, the FTYPE code, which is formed of 1 byte, can distinguish 256 file types. If it is necessary to distinguish more file types, 2 bytes may be prepared for the FTYPE code. Also, several bytes may be prepared as a reserved space after the FTYPE code. In the embodiment, that is not essential for the present invention and the description thereof will be omitted.

An OFFSET code is followed by the FTYPE code. The OFFSET code serves to indicate the storage position of the file content information of the file. Then, a management program code, which is a primary part of the embodiment, is followed. Further, the file content information is followed. The file content information is formed of substantial content data of the file. If the file content information is a program file, the content data are formed of a program code and auxiliary data for the program code.

FIG. 12 shows an example of another file structure in the case where the management program code follows the file content information. In this case, the OFFSET code, in turn, indicates the position of the management program code.

The management program code does not depend on the types of file such as a data file and a program file. In the embodiment, it is supposed that a file having the file structure according to the embodiment has the format as shown in FIG. 9 and FIG. 10.

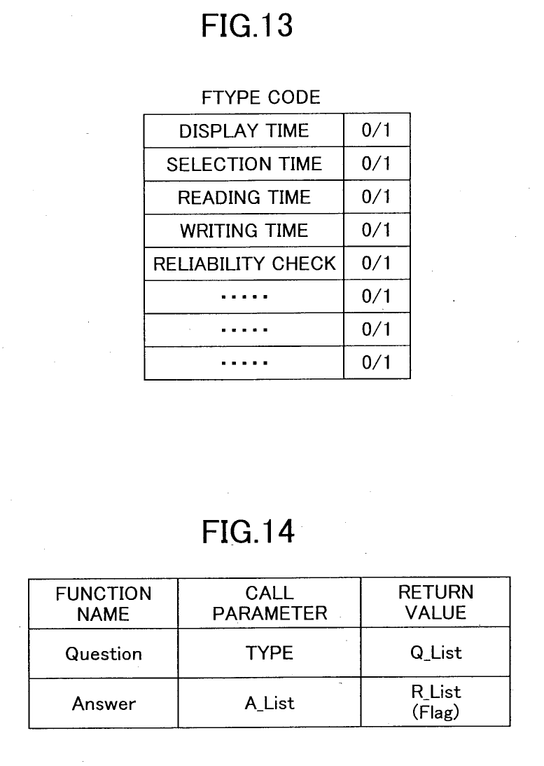

A description will now be given, with reference to FIG. 13, of an example of codes that the FTYPE holds in such a file structure. As is shown in FIG. 13, individual FTYPE codes indicate operational modes for the management program code by using a sequence of bits. The value “1” of a bit means that an operational mode corresponding to the bit is valid. In contrast, the value “0” of the bit means that the operational mode is not valid. If all of the bits for the FTYPE codes have “0”s, the management program code does not operate at all. If the bit corresponding to the display operation has “1”, the management program code operates at the time of the list display execution. Also, if the bit corresponding to the selection operation has “1”, the management program code operates at the file selection time through the input apparatus such as the mouse 11. Not only when an icon representing a file is clicked but also when a pointer is simply positioned on the icon, may the file be considered to be selected.

If the bit corresponding to the reading operation has “1”, the management program code operates before an application program reads a file. If the bit corresponding to the writing operation has “1”, the management program code operates when an application program updates a file: Additionally, if the bit corresponding to the reliability examination has “1”, the management program code operates when a virus check program is executed to examine the reliability of a file.

As mentioned above, the FTYPE information holds codes to indicate the time when the operating system actuates the management program code. Although the time when the computer 1 operates the management program code of a file in the embodiment is described in the FTYPE information, description methods other than the FTYPE information may be used. For instance, the execution time of the management program code may be prescribed for each event of the computer 1. In detail, the execution time may be prescribed for the click, the double-click, and the drag and drop of the mouse 11. The FTYPE codes serves as the flags for restricting unnecessary burdens on the computer 1, that is, the execution of the management program code for all events.

A description will now be given of an operation for the management program code in a file. In a conventional file structure, the management program code of a file is added to a program code or an image, so-called file content information. As mentioned above, there is a possibility that the file is created before the development of an operating system. Also, the management program code often operates depending on the type of file content information. In order to overcome the above problems, the management program code contained in a file shown in FIG. 9 and FIG. 10 has an interface uniformly prescribed for operating systems so that the operating systems can call the management program codes of various types of file in a uniform fashion. Here, the call operation can be prescribed by an application program for creating a data file and a manufacturer producing the application program. When the management program code having the prescribed interface is added to the conventional file and the operating system calls the file management program (file name display program), the file management program can successfully operate without the alternation regardless of the file type and operation.

On the other hand, a program for calling the management program code based on the prescribed interface is included in the operating system. The management program code called by the operating system operates in accordance with the type of file.

A description will now be given, with reference to FIG. 14, of an example of the interface for calling the above-mentioned management program code. The operating system calls two types of function shown in FIG. 14: a Question function and an Answer function. The Question function has the call parameter TYPE and the return value Q_List. The Answer function has the call parameter A_List and the return value R_List (there is a case of only flags.). The TYPE, the Q_List, the A_List and the R_List in FIG. 14 will be described in detail later.

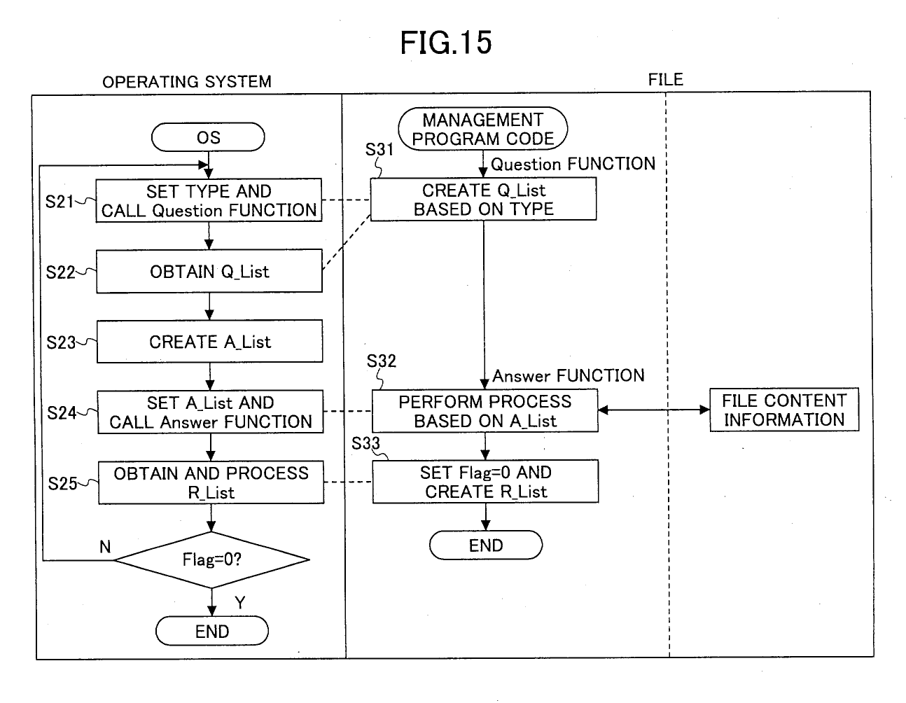

FIG. 15 shows a process outline of the operating system and the management program code. It is supposed that the operating system obtains the validity of the reading operation based on the FTYPE information as shown in FIG. 13. The operating system sets the TYPE information indicating the operational time (or the event) in accordance with the FTYPE and calls the Question function of the management program code (S21). The called Question function of the management program code determines a type of information necessary to execute the Answer function based upon the TYPE information and creates the Q_List (S31). For instance, when the display operation is performed, the operating system sets the TYPE information indicating the display operation and calls the Question function. The Question function of the management program code creates the Q_List including environment information such as the display width, the display height and resolution required to execute the Answer function based upon the TYPE information and returns the Q_List to the operating system.

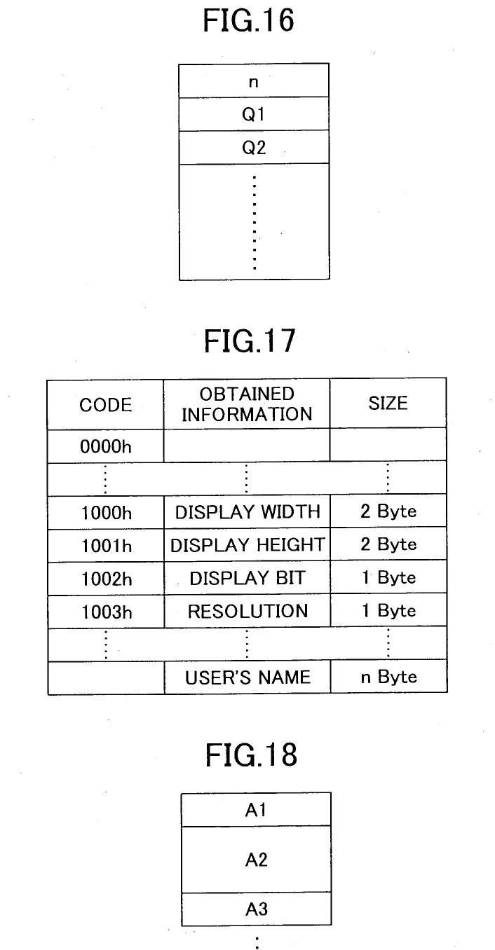

FIG. 16 shows a data structure of the Q_List. The Q_List begins with the number n of required information items (the number of types), and codes of the information items Q1, Q2, . . . , Qn are arrayed corresponding to the number n of required information items. It is an efficient way to prescribe the type code by the proper number of bytes, and the type code is represented by 2 byte code in the embodiment of the present invention. FIG. 17 shows a table representing a correspondence of the codes to the types of environment information that the management program code should obtain from the Q_List in the embodiment. The table is prescribed and registered in the operating system in advance. The management program code obtains the information items shown in the column “Information Item” in FIG. 17 via the operating system. These information items are related to the environment information such as an output apparatus and an input apparatus connected to the computer 1. The information items have property information as follows: the numbers of display dots of the display 9 in the vertical and the horizontal directions, the display color of the display 9, a type of the keyboard 10, a default font type and a default size of the operating system, and a language such as Japanese and English used by the operating system. As is shown in FIG. 17, the display area and resolution are typical information items. Fundamental information items required for operations by the operating system are coded in the information items. Also, since the size depends on the type of information, it is necessary to prescribe the size of information. FIG. 17 shows an example of the information sizes. Here, when an information item has a variable size rather than a fixed size, the information size is prescribed as an “n Byte” as shown in FIG. 17 so that the information can be delivered by coupling the information size n and the information.

Then, the operating system obtains the Q_List created by the Question function of the management program code (S22). Based upon the table in FIG. 17, the operating system detects information necessary for the management program code from the Q_List formed of a code sequence of information items and then creates the A_List as shown in FIG. 18 corresponding to the detection result (S23). The A_List is a sequence of the property information items corresponding to each code of the Q_List. The operating system sets the created A_List and calls the Answer function of the management program code (S24).

Based upon the A_List, the called Answer function performs a process with reference to the file content information (S32). At this time, there are two cases regarding the process of the Answer function. In one case, the Answer function performs the process directly for the computer 1. In the other case, the Answer function performs the process and delivers a process result to the operating system. Then, the operating system displays the process result on the computer 1.

In the case in which the Answer function performs the process directly for the computer 1, the Answer function sets Flag indicating whether or not another process is further necessary after the process and return the Flag to the operating system. The operating system determines whether or not to further execute the management program code based on the Flag value. If the execution of the management program code is required (Flag=1), the above-mentioned process is repeated. Otherwise (Flag=0), the process is terminated.

In the latter case in which the operating system displays the process result, if any process is not further necessary, the Answer function sets the Flag as “0” and returns the Flag together with the process result (which may be NULL) as R_List to the operating system (S33). If some processes are necessary, the Answer function sets the Flag as “1” and returns the Flag together with the process result (which may be NULL) as the R_List. The operating system obtains the returned R_List and performs further processes for the process result of the Answer function if necessity (S25). Then, the operating system displays the process result on the display 9. Furthermore, the operating system determines whether or not to execute the management program code based on the Flag value (S26). If it is necessary to execute the management program code (Flag=1), the above-mentioned process is repeated. Otherwise (Flag=0), the process is terminated.

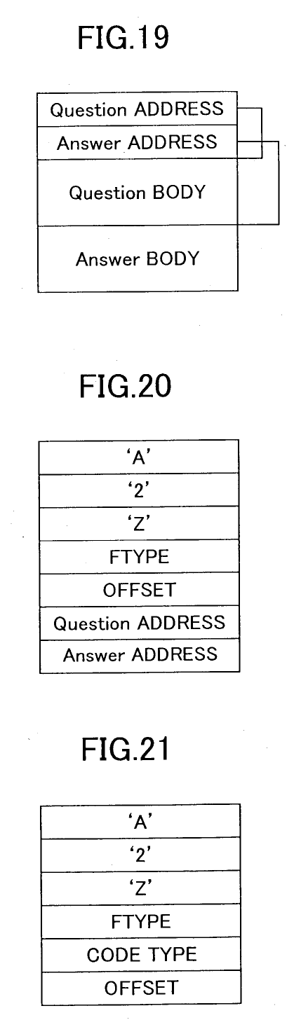

As is shown in FIG. 19, the position information of the two functions may be maintained in the head of the management program code. Also, the structure as shown in FIG. 20 may be maintained in the header in FIG. 11. In FIG. 19, addresses of the Question function and the Answer function are stored in the head of the management program code, and the bodies of the Question function and the Answer function are stored in the train of the address information. In contrast, in FIG. 20, the addresses of the Question function and the Answer function are stored in the last portion of the header. Under this configuration, the operating system only calls the management program code based on the prescribed interface. As a result, it is possible to install how to operate in detail even after the development of the operating system. For instance, it is possible to properly represent information required to select a file.

Although the management program code may be described by a language code depending on the CPU 2 of the computer 1, there is a case in which it is desirable to describe the management program code by using an intermediate language code such as JAVA (registered trademark of Sun Microsystems, Inc.) because it is possible to execute a file even by using computers having different types of CPU.

When there are a plurality of program codes describing the management program code, a file header as shown in FIG. 21 is prepared. In this case, the flag “CODE TYPE” is provided in the header, for instance, between the FTYPE and the OFFSET. For instance, the value “1” of the CODE TYPE means that the management program code is described by using the JAVA byte code. The value “2” means that the management program code is described by using an intermediate language code such as C#. The value “3” means that the management program code is compatible to Intel 8080 that is primarily used as CPU of personal computers.

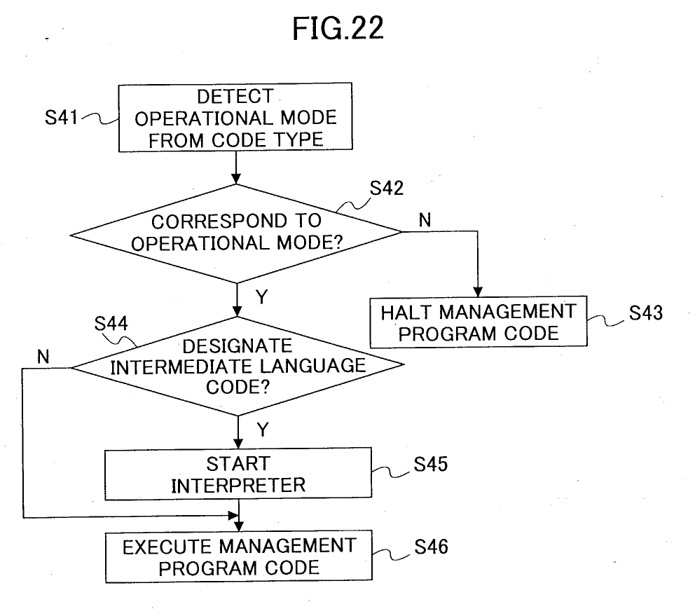

The operating system performs such a process as shown in FIG. 22 for a file having the file header shown in FIG. 21. The operating system finds an operational mode from the CODE TYPE, which is in the file header of the file, before the execution of the management program code. Then, the operating system determines whether or not the computer 1 can deal with the operational mode designated by the CODE TYPE (S42). If the management program code is described by using a language code other than code types that the computer 1 can execute or the computer 1 has no module such as an interpreter for executing the intermediate language code, the operating system cannot execute the management program code and terminates the execution (S43). In contrast, if the computer 1 can deal with the operational mode designated by the CODE TYPE, the operating system determines whether or not an intermediate language code is designated (S45). If the intermediate language code is designated, the operating system starts a module such as an interpreter corresponding to the type of the intermediate language code (S45). Then, the operating system executes the management program code (S46). On the other hand, if a language code is designated, the operating system directly executes the management program code (S46).

Here, the management program code may be described by using a plurality of language codes such as a native language code and an intermediate language code, and a file may have a plurality of management program codes. In this case, if the management program code is described by using the native language code of the CPU 2 of the computer 1, the operating system executes the management program code for the native language code. Otherwise, the operating system executes the management program code for the intermediate language code.

The management program code is often sufficient if the management program code has functions of describing the contents of the file. Thus, the functions that the management program code can execute may be restricted. Under the restricted management program code, even if a malicious program such as a computer virus invades the management program code, it is possible to prevent the execution of the malicious program.

In detail, when the management program code is described by using the JAVA byte code, the security manager attached in the JAVA language is used. The Java program can perform functions within an authorized range called a “sandbox”. Also, the JAVA program can be set so that the JAVA program can perform only certain functions, in other word, the JAVA program is not allowed to perform functions other than the certain functions. The primary purpose of the management program code according to the embodiment is to display the contents and status of a file. Thus, for instance, if it is not allowed to perform operations such as writing in a local file, starting other programs, and connecting to a network, the operating system can achieve the function restriction by calling the management program code in a state of giving no permission for the execution of these functions.

Also, the management program code may be designed to read only file content information of a file having the management program code. In this case, the management program code obtains various information items from the above-mentioned A_List and commits an output process of an operation result to the operating system. As a result, the operating system achieves the function restriction in the state of giving no permission for the execution of the functions by calling the management program code. Here, the management program code only serves to create new information based on given information and file content information contained in the file. The operating system serves to output the information. Under this configuration, it is possible to prevent the execution of the malicious program such as a computer virus in the management program code.

In detail, the operating system delivers the various information items as the A_List to the Answer function and calls the Answer function. The Answer function performs the process by using the file content information and returns the Flag information together with information to be displayed on the display 9 as the R_List to the operating system. The operating system displays the received information to be displayed on the display 9 instead of the Answer function. The Answer function converts the information to be displayed into image data and delivers the image data to the operating system including the R_List. As a result, it is possible to easily achieve the functions in the state of giving no permission for the execution of the functions by calling the management program code.

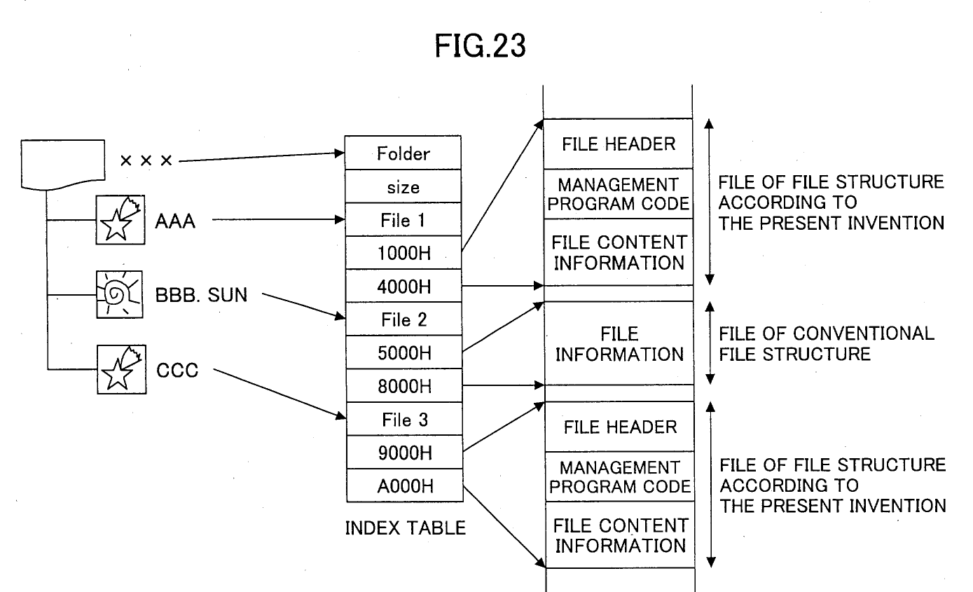

While the conventional file structure maintains only the file content information representing the contents of a file, the file structure according to the embodiment has only the management program code in addition to the file content information. As a result, it is possible to store a plurality of files in the storage apparatus such as the HDD 5 under the structure similar to that in FIG. 3. FIG. 23 shows this example.

The computer 1 basically accesses an index table representing the contents of a plurality of files and file content information of the files in the storage apparatus such as the HDD 5 in order to obtain the desired information. The storage apparatus is supposed to provide a virtual hierarchical structure and maintain three files AAA, BBB.SUN and CCC in a folder XXX in the hierarchical structure. Furthermore, it is supposed that the files AAA and CCC have the file structure according to the present invention and the file BBB.SUN has a conventional file structure. As mentioned above, these files maintain the storage location information of the file content information in the index table. The index table maintains the folder name representing the folder XXX, the number of files (size) in the folder, file names, and the storage location information of the file content information (here, the start address and the end address). Similarly to the description with respect to FIG. 3, the file content information of an individual file is stored at the storage location maintained in the index table.

As is seen in FIG. 23, when the storage location of the file having the conventional file structure is designated, only the file content information is appointed. However, when the storage location of the file having the file structure according to the present invention is designated, the entire file structure as shown in FIG. 9 and FIG. 10 is appointed. Thus, even if the file structure according to the present invention is used, it is possible to realize the storage structure in which files according to the present invention and files having the conventional file structure are maintained together. Furthermore, it is possible to directly use the conventional file storage structure without necessity of adopting a new storage structure for storing the files having the file structure according to the present invention.

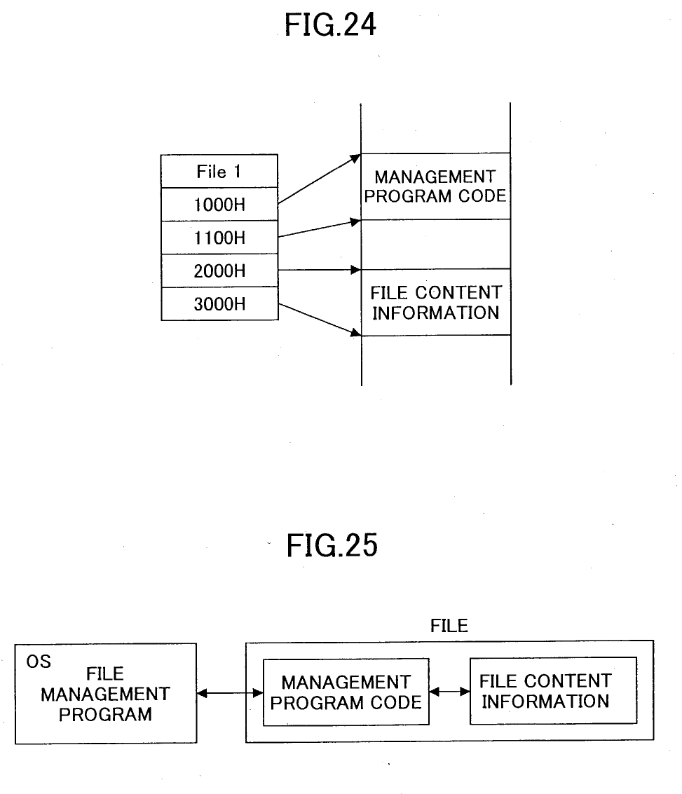

Here, as is shown in FIG. 24, the file storage information may be maintained in the index table differently from the conventional fashion. Namely, the storage location information (the start address and the end address) of the management program code and the storage information (the start address and the end address) of the file content information may be separately maintained. In this case, since the operating system can obtain separately the two storage information items of the management program code and the file contents information, it is possible to achieve the high speed access. However, on the contrary, it is difficult to manage files because the two storage information items are maintained in different locations. As a result, when the files are copied and moved in another storage apparatus, it is also necessary to copy and move the storage location information of the two information items.

According to the novel file structure having the management program code according to the present invention, the management program code serves as a mediator between the operating system to assist a user to operate a file and the file content information of the file. The management program code is prescribed uniformly to all files and is formed as a program having the interface that the operating system can call in a uniform fashion. The operating system is sufficient to call the management program code based on the interface. In contrast, even if a data file has any format, an application program can display the data file in the desired form simply by creating a program for performing the process to assist user's file operations such as the icon display and the thumbnail display of the file based on the prescribed interface as mentioned later. The operating system calls the management program code so as to perform the process to assist the user's file operations and causes the management program code to only execute the process. Accordingly, it is unnecessary to start the application program for the file. Thus, the file structure according to the present invention differs from conventional file structures in that the application program is included in the file under the conventional file structures. Furthermore, the management program code is added when the file content information of the file is created. The management program code can interpret the format of the file and the operating system is sufficient to call the management program code. As a result, the management program code is applicable to even the case in which the application program of the file is developed after the operating system. In addition, by eliminating the disadvantages such as the extension dependency, the file structure according to the present invention achieves the high generality in that the file structure does not depend on the difference of the development time between the operating system and application programs used in the computer.

A description will now be given of a creation method of a file having the file structure according to the present invention.

From the viewpoint of the file creation method, files in the storage apparatus such as the HDD 5 of the computer 1 are classified into two types. The first type file is a file that is created in advance by operating system providers and application program providers at the development time of these programs. Typically, program files constituting the operating system and files of the application programs are classified as the first type file. The second type file is a file that is created by programs of the computer 1. Typically, document files are classified as the second type file.

In a creation method of the first type file, a provider of such a file creates necessary information (file content information) and management program code according to the present invention. Then, a file in which the file content information and the management program code are integrated is created by using the file structure according to the present invention as shown in FIG. 9 or FIG. 10.

In a creation method of the second type file, the program for creating such a file (application program and so on) produces the file content information necessary for storage and the created management program code under the file structure shown in FIG. 9 or FIG. 10.

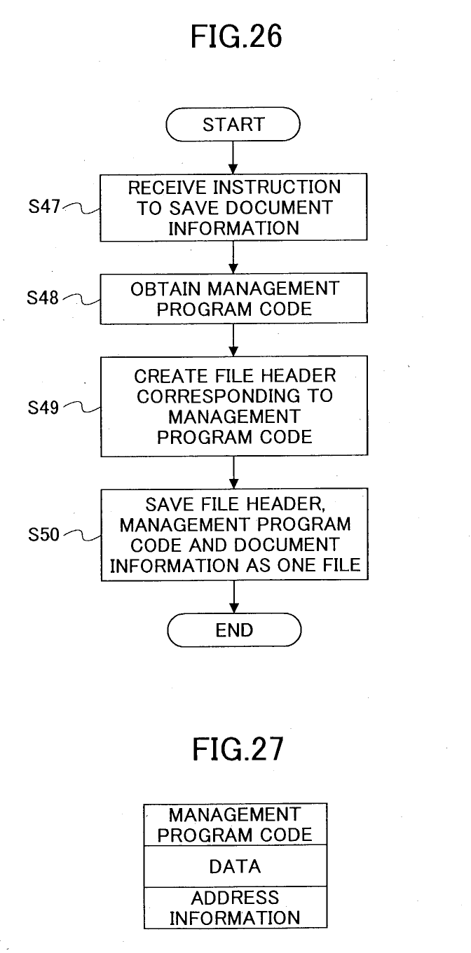

For instance, FIG. 26 shows a flowchart of a document creation program. Referring to the flowchart in FIG. 26, when a document creator saves document information as a file in the storage apparatus, the document creation program receives an instruction to save the document information (S47). The document creation program obtains the management program code provided in advance by the document creation program provider (S48). The document creation program integrates the management program code and the document information by using the file structure shown in FIG. 9 or FIG. 10, or demonstrates that the file structure according to the present invention is applied to the file and generates the file header including information corresponding to the management program code (S49). Then, the document creation program saves the management program code and the document information together with the file header as a file in the storage apparatus (S50).

Here, the management program code is prepared in advance by the provider of the document creation program.

The file structure according to the present invention may be applied to a browser program (application program) for browsing a Web page in the Internet. The browser program has a function of saving addresses of browsed Web pages. This function is often called a “bookmark”. In the bookmark, the addresses (URL: Uniform Resource Locator) are stored and managed as individual files in a certain folder. For instance, Internet Explorer provided by Microsoft Corporation adopts the above-mentioned bookmark function.

The file structure according to the present invention may be applied to individual files of the address information in the bookmark. As is shown in FIG. 27, the individual files in the bookmark hold the management program code and data together with the address information of Web pages. Here, for instance, the data may be image data (display image information) roughly showing the Web page of the address.

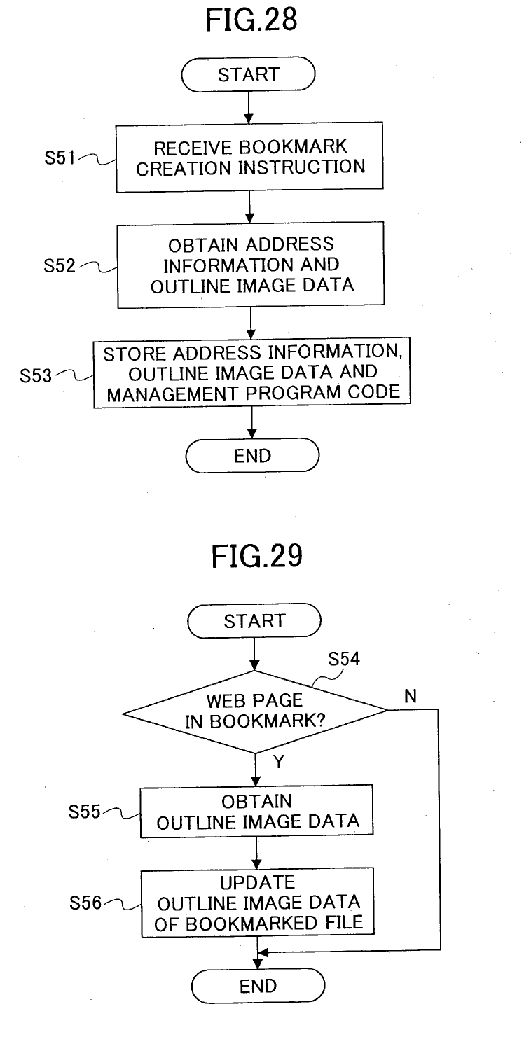

A description will now be given, with reference to FIG. 28, of an example of a file creation process as shown in FIG. 27. A user browses a Web page by means of a browser program and instructs to create the bookmark for a certain page, and the browser program receives the bookmark creation instruction (S51). The browser program obtains the address information of the Web page and image data (display image information) roughly showing the browsed Web page (S52). Then, the browser program saves the address information and the image data together with the management program code prepared in advance by a provider of the browser program as a file having the file structure according to the present invention in the storage apparatus (S53).

If such a file for the bookmark is created, the management program code displays the image data roughly showing the Web page like an example of an image file to be mentioned later when the file name display program displays a list of addresses in the bookmark at the next time. As a result, the user can find the desired address in the bookmark more easily than when the user searches the bookmark by using only the address information.

Additionally, since Web pages are quite often updated, it is preferable to also update the above-mentioned image information. In this case, a process as shown in FIG. 29 is performed. When the user browses a certain Web page by means of the browser program, the bookmark folder is searched for the bookmarked file having the same address information as the Web page (S54). If a file having the same address is found, image data (display image information) roughly showing the Web page at present is obtained (S55). Then, the image data of the file is updated (S56).

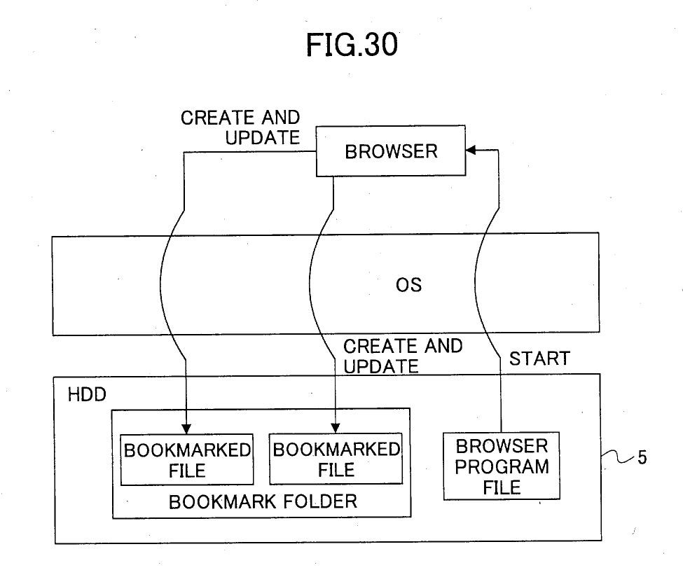

FIG. 30 is a block diagram illustrating the process outline described with respect to FIG. 28 and FIG. 29.

Here, the management program code in the bookmarked file may cause the browser program periodically to obtain image data (display image information) and update the display image information based on the image data. Also, if possible, the management program code may automatically obtain image data (display image information) and update the display image information.

Heretofore, the file structure according to the present invention and the creation method thereof have been mainly described. In the following, a description will now be given of how to use a file having the file structure according to the present invention.

The primary purpose of the file structure according to the present invention is to enable a user of the computer 1 to easily select a file. Thus, a description will now be given of the file name display program (file management program) contained in an operating system. The file name display program serves to display a plurality of files in a folder and causes the user to select a certain file among the files or executes a certain file. Explorer of Windows is a typical file name display program.

As is shown in FIG. 23, when the folder XXX contains the files AAA and CCC having the file structure according to the present invention and the file BBB.SUN having the conventional file structure, the index table maintains the storage location information of file information that is stored in the structure as shown in FIG. 23.

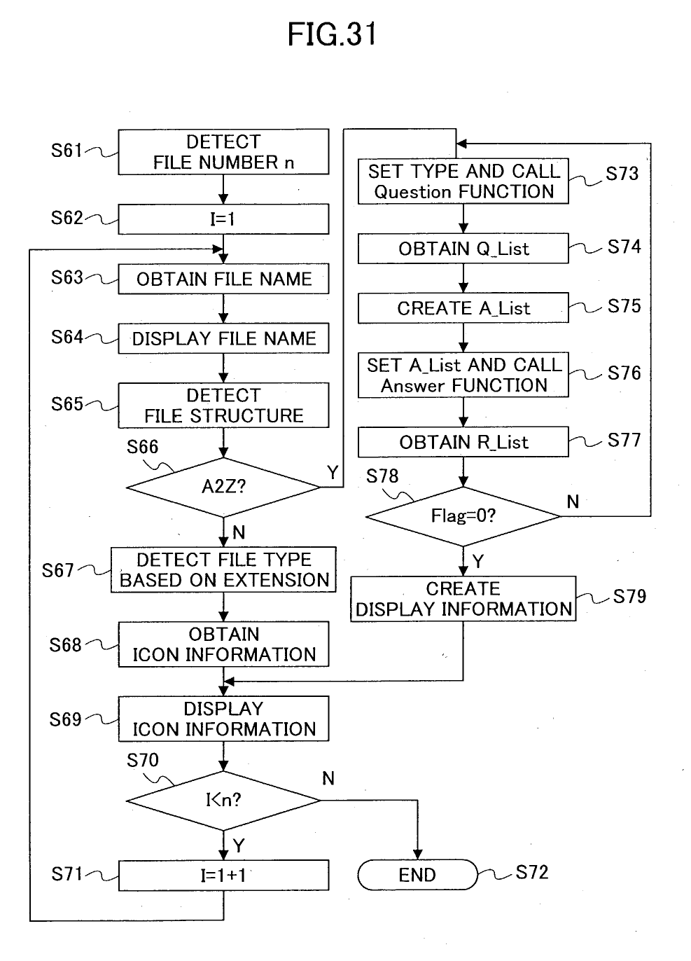

In this case, the file name display program performs a process represented as a flowchart in FIG. 31 and displays a list of file information items. In FIG. 31, the file name display program obtains the number of files n to be displayed in a folder from the index table (S61). In detail, the file name display program reads data in the column “size” of the index table in FIG. 23. Also, the file name display program initializes the counter I as “1” (S62).

Subsequently, the file name display program obtains file names in the folder (S63). In detail, the file name display program reads and displays the file identification information in the index table in FIG. 23 (S64). The file name display program detects file structures (S65). In detail, the file name display program obtains the storage location information (the start address and the end address) of the file information from the index table and reads the file header in the file information.

In the file having the file structure according to the present invention (FIG. 12), the file name display program reads a magic number from the file header at the top of the file. Since the magic number is set as the three-byte ASCII code “A2Z” in this embodiment of the present invention, the file name display program determines whether or not the file has the character sequence “A2Z” in initial 3 bytes of the file (S66). If the initial 3 bytes of the file do not match “A2Z” (S66: N), it is concluded that the file follows the conventional file structure. Accordingly, the file name display program identifies the file type based on the extension in the file identification information (S67). Then, the file name display program obtains the icon information corresponding to the file type from a correspondence table registered in advance (S68) and displays image data of the icon information (S69). The above-mentioned process is repeated as many times as the number of files n (S70 and S71).

If the initial 3 bytes of the file matches “A2Z” (S66: Y), the file name display program calls the management program code of the file of interest as described with reference to FIG. 15. In detail, the file name display program sets the TYPE to indicate the display operation and calls the Question function of the management program code (S73). As mentioned above, the Question function generates the Q_List. The Q_List is related to the display necessary for the display operation based on the TYPE and indicates the type of property information of a computer.

The file name display program obtains the Q_List returned by the Question function (S74) and creates the A_List, which is the property information of the computer necessary for the display operation (S75). The file name display program sets the A_List and calls the Answer function (S76). The process of the steps S73 through S75 is performed as a preprocessing function.

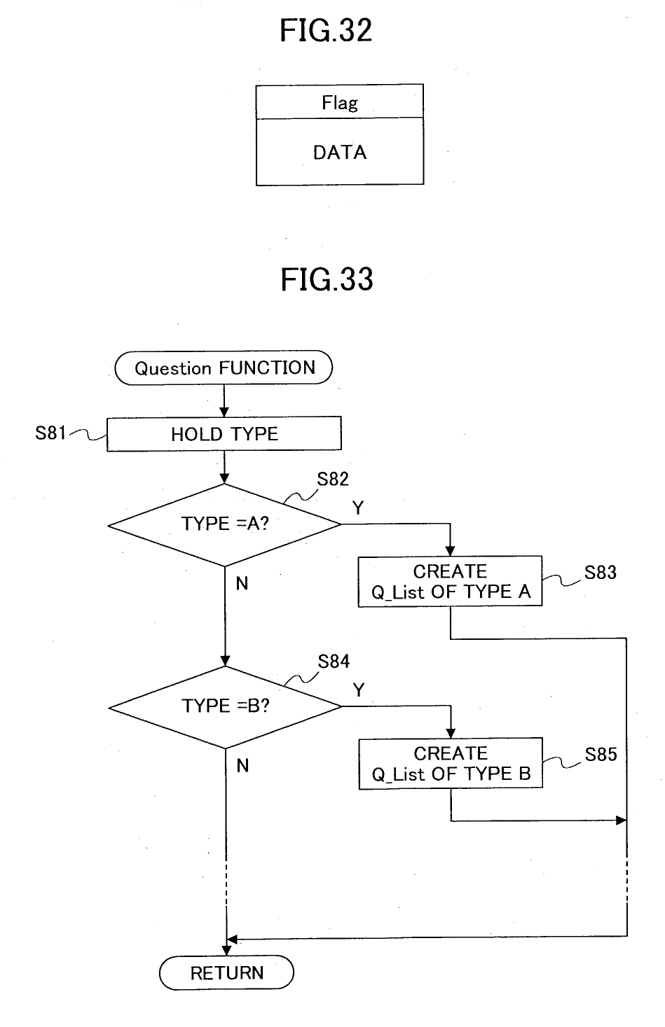

The Answer function of the management program code generates display data from the file contents information based on the A_List and returns the R_List formed of the display data and the above-mentioned Flag (ref. FIG. 32). For instance, if the file content information is document data, the display data thereof is brief description information or reduced image data. If the file content information is image data, the display data thereof is a portion of the image or a reduced image (thumbnail). On the other hand, the file name display program obtains the R_List (S77) and determines whether or not the Flag therein has “0” (S78). If the Flag has “1”, the file name display program sets the TYPE similarly and calls the Question function again to iterate the following process.

On the other hand, if the Flag has “0”, the file name display program creates the display information from the R_List (S79). In detail, if the R_List contains bitmap data, the bitmap data is directly used as the display information. Then, the display information is displayed on the display 9 (S69) The process of the steps S79 and S69 is performed as a postprocessing function.

The above-mentioned process is performed for all files in the folder (S70 and S71). As a result, it is possible to display the file names and the icons of the both type of files; the file having the file structure according to the present invention and the file having the conventional file structure. Also, by calling the management program code, the file name display program can display information created by the management program code contained in the file having the file structure according to the present invention. Namely, by calling the management program code of the prescribed interface, it is possible to flexibly display the information in accordance with the property of a file. As a result, the user can easily select the desired file.

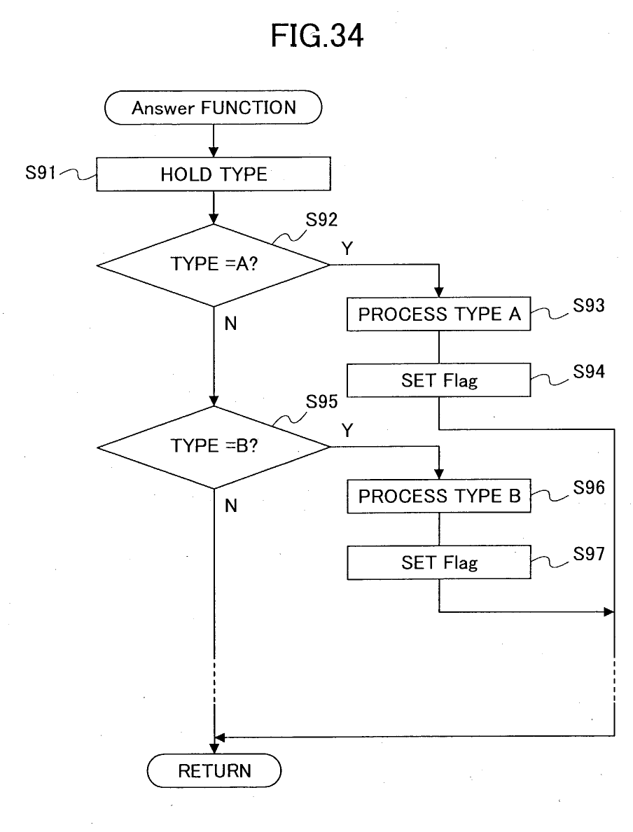

A description will now be given of implementation of the management program code with respect to various file formats in detail. FIG. 33 and FIG. 34 show flowcharts of conventional processes for the Question function (routine) and the Answer function (routine) of the management program code. In FIG. 33, when the Question function is called by a call program such as the file name display program, the Question function holds the TYPE delivered by the call program (S81). The Question function creates the Q_List based on codes regarding information type necessary for the Answer function for each TYPE (S82, S83, S84, S85, . . . ) and returns the Q_Lists to the call program.

On the other hand, as is shown in FIG. 34, the Answer function obtains the TYPE information (S91) and performs a predetermined process for each TYPE maintained in the Question function. If necessary, the Question function sets the Flag (S92, S93, S94, S95, S96, S97, . . . ) and returns the Flags to the call program.

Here, when the Answer function commits the display process to the call program in the operating system rather than directly performs the display process as shown in FIG. 32, the Answer function performs a predetermined process for each TYPE. Then, the Answer function creates the R_List containing the process result and the Flag and returns the R_List to the call program.

As mentioned above, the Question function only creates the Q_List formed of a list of information items necessary for the Answer function based on the TYPE information indicating the operational mode of the management program code. In contrast, the Answer function only uses the necessary information items obtained as the A_List to perform the process corresponding to the operational mode. In other word, the Question function determines the necessary information items based on a status of the call program, and the Answer function uses the obtained necessary information to perform the process corresponding to the status of the call program.

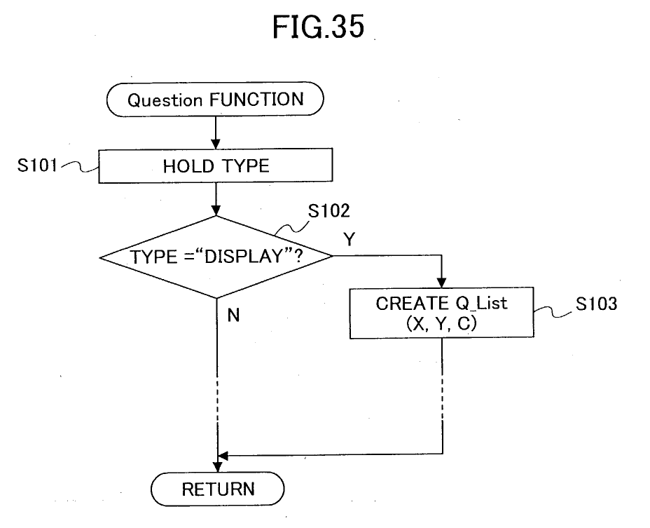

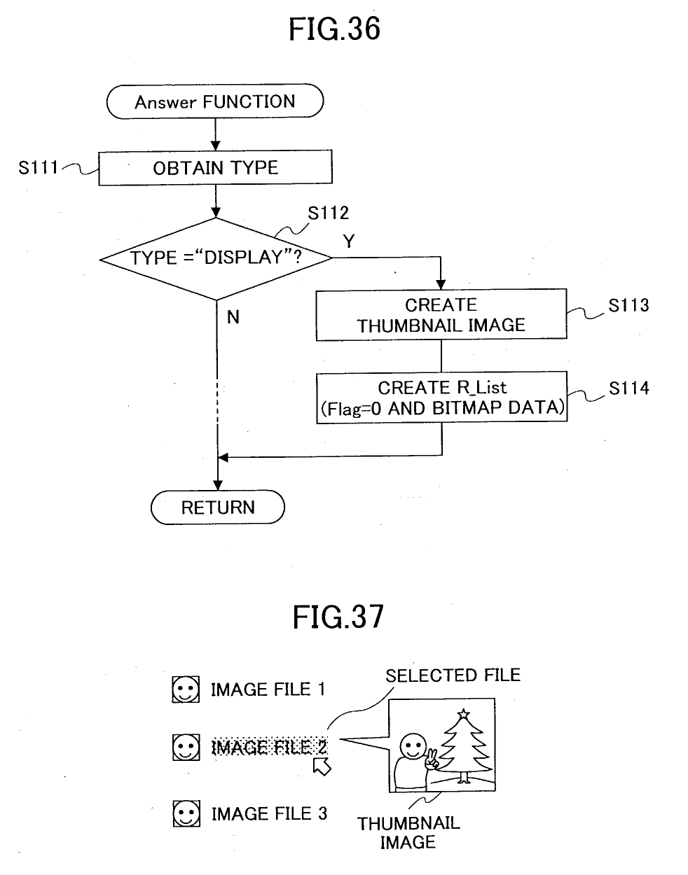

FIG. 35 and FIG. 36 show examples of the management program code when the file structure according to the present invention is applied to a file having image information (still image) as the file content information. When a certain file is selected among a plurality of image files, the user can easily select the file if thumbnail images of the image files are displayed. In this case, in order to display such an image as the thumbnail image in a list of image files, it is necessary to obtain information such as the display area and the display color size for displaying the thumbnail image.

In this case, the Question function of the management program code holds the TYPE information delivered by the call program (S101). If the TYPE information has the value “DISPLAY” (S102: Y), the Question function creates the Q_List containing the display area constituting the horizontal size (display area X) and the vertical size (display area Y) and the display color size C for displaying the thumbnail image (S103).

Then, the Answer function of the management program code obtains the TYPE information maintained by the Question function (S111). If the TYPE information has the value “DISPLAY” (S112: Y), the Answer function uses the file content information of the image file to create the thumbnail image based on the display area (X and Y) and the display color size C that the call program sets in the A_List (S113). The thumbnail image can generally be created by performing sub-sampling from the source image information. Since the creation method is well-known and is not primary part of the present invention, the further description thereof will be omitted. The Answer function returns the bitmap data and the Flag of the created thumbnail as the R_List to the call program (S114). If the image file is a still image file, the Flag may be set as “0”. The call program displays the thumbnail image based on the bitmap data.

It should be noted that since the management program code according to the present invention is added at the time of the image information creation of the image file, the management program code can interpret the format of the image file. Thus, even if the format of the image file is designed after the development of the file name display program and the operating system, it is possible to display the thumbnail image by using the management program code.

Although FIG. 35 and FIG. 36 illustrate the case of the still image, the management program code according to the present invention is also applicable to a moving image file. For instance, the Answer function creates a thumbnail image of the moving image at a time point. Additionally, the Answer function creates the R_List containing the thumbnail image and the Flag having the value “1”. Consequently, the call program pertaining to the operating system displays the thumbnail image as a flash image. The call program sets the TYPE and calls the Answer function and the Question function again. Then, the Answer function creates a thumbnail image of the moving image at a time point after the above time point. Additionally, the Answer function creates the R_List containing the thumbnail image and the Flag having the value “1”. The above-mentioned process is repeated. As a result, when the file name display program displays a list of files, it is possible to display the moving image file as a series of flash images of thumbnail images.

In general, the following three steps are performed so as to operate a certain file. The first step is related to the process “List Display”, the second step is related to the process “File Selection” and the third step is related to the process “File Own Operation”. Normally, at the first step, the file name display program or the like displays a plurality of files. At the second step, a user selects a certain file among the displayed files. At the third step, a desired operation is performed for the selected file.

Conventionally, when an image file or the like is displayed by means of an application program and so on, the second step is omitted. That is why the conventional system gains no benefit by performing the second step.

On the other hand, with respect to the file structure having the management program code according to the present invention, the user can gain some benefits at the user's file selection For instance, there is a problem at the file list display time in that individual thumbnail images are reduced so as to display a plurality of files. In order to overcome the problem, the file structure according to the present invention can display larger thumbnail image at the selection time. Namely, when the TYPE, which is set by calling the Question function, indicates the selection time, the management program code can create larger thumbnail images than when the TYPE indicates the list display time. It is possible to realize the above function by changing the size of display area of the A_List.

Also, the management program code may simply display an icon for the image file at the list display time and a thumbnail image at the selection time. FIG. 37 illustrates this case. In FIG. 37, icons and file names of “image file 1”, “image file 2”, and “image file 3” are displayed, and the “image file 2” is selected. It is possible to select a file by clicking a file name or an icon by a pointing device such as a mouse or by positioning a pointer on the file name or the icon.

When the operating system (or the file name display program) detects the superposition of the pointer on a predetermined area for the “image file 2”, the operating system considers that the “image file 2” is selected. Then, the operating system sets the TYPE as the selection time and calls the Question function of the management program code of the “image file 2”. The Question function holds the TYPE indicating the selection time and returns information items necessary for the selection operation such as the display area size and the display color size as the Q_List to the operating system. The operating system sets the property information corresponding to the Q_List as the A_List. In this case, the operating system sets the display area size corresponding to the selection time as the A_List and calls the Answer function. The Answer function deals with the file content information in accordance with the A_List. Then, the Answer function creates the thumbnail image as shown in the right side of FIG. 37 and returns the thumbnail image and the Flag having the value “0” to the operating system. The operating system obtains the R_List and displays the thumbnail image in the R_List at a proper position on the screen of the display 9.

In the above example, the description is given of the process for the image file at the file list display time and the file selection time. Furthermore, the file structure according to the present invention is applicable to the case of an audio file. Namely, an icon representing an audio is displayed at the list display time, and a portion of the audio is reproduced at the selection time. In this case, when the operating system (the file name display program) detects the superposition of the pointer on a predetermined area of an audio file, the operating system determines that the audio file is selected. Then, the operating system sets the TYPE to be at the selection time and calls the Question function of the management program code in the audio file. The Question function holds the TYPE representing the selection time and returns information items necessary for the selection time such as the availability of sound functions and available formats for the audio output as the Q_List to the operating system. The operating system sets the property information corresponding to the Q_List as the A_List. In this case, the operating system sets the information items necessary for the selection time such as the availability of sound functions and available formats for the audio output as the A_List and calls the Answer function. If the sound function is available in the computer 1, the Answer function deals with the file content information in accordance with the A_List. For instance, the Answer function creates a portion of the audio information in a prescribed format and returns the portion of the audio information and the Flag having the value “0” as the R_List to the operating system. Also, the output of the audio information may be repeated by setting the Flag as “1”. The operating system obtains the R_List and causes the sound function to reproduce the audio information contained in the R_List.

Here, the Answer function may be provided to cause the computer 1 directly to output an audio. In this case, it is necessary to implement an apparatus and a method for overcoming the difference of the sound functions.

Heretofore, the description is given of the file operations such as the display and the reproduction of file content information. In the following, a description will now be given of a method for displaying the availability of the file content information.

In general, when a certain file is used, it is necessary to prepare for a program for processing the file (application program) and a computer environment. For instance, when an audio file is reproduced, it is necessary to connect between the computer 1 and an audio synthesizer and install a program for controlling the audio synthesizer in the computer 1. The operating system serves to control the connection between the apparatuses and the program, and the management program code can detect the connection via the operating system (environment information obtaining part).

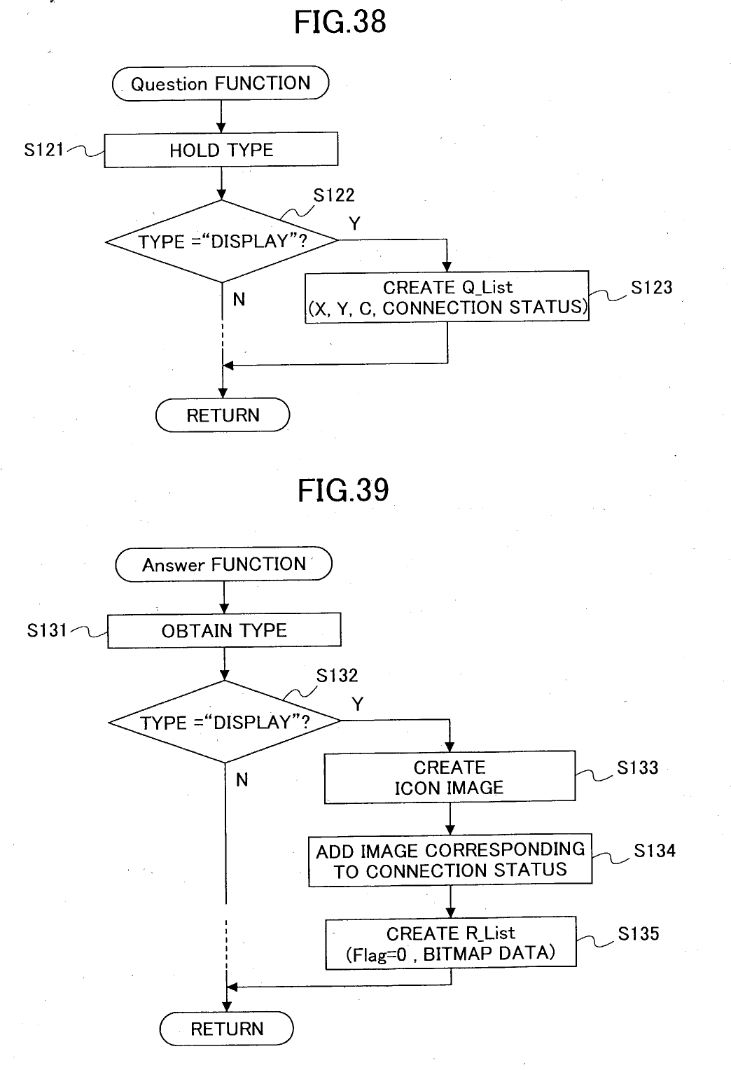

Thus, for instance, at the list display time, the operating system (or the file name display program) sets the TYPE representing the list display time and calls the Question function for each file. As is shown in FIG. 38, the Question function holds the TYPE delivered by the operating system (S121) and creates the Q_List for the list display (S122: Y and S123). The Q_List contains the horizontal size X and the vertical size Y of the display area and the display color size C together with an information item (environment information item) regarding the connection between apparatuses. When the operating system obtains the Q_List, the operating system sets the display area size (X, Y) and the display color size C together with the information item regarding the connection between apparatuses as the A_List and calls the Answer function.

As is shown in FIG. 39, the Answer function obtains the TYPE held by the Question function (S131) and performs the process corresponding to the TYPE (list display) (S132: Y and S133 through S135). Based upon the display area (X, Y) and the display color size C, the Answer function creates an icon image (S133). Here, the Answer may already hold the icon image. The Answer function adds an image corresponding to the information regarding the connection contained in the A_List to the icon image (S134). Then, the Answer function creates the R_List from the Flag having the value “0” and bitmap data of the icon image (S135). The operating system uses the bitmap data in the R_List to display the icon.

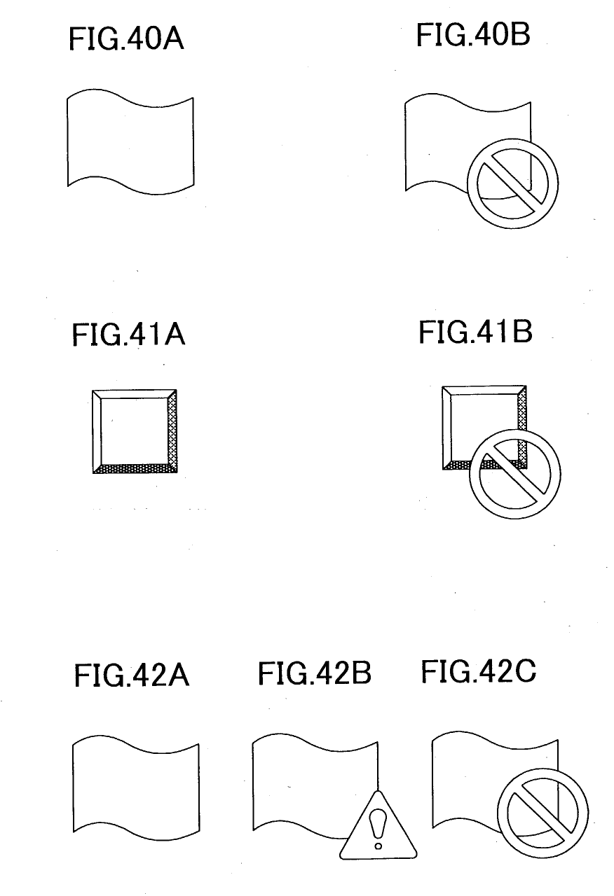

FIGS. 40A and 40B show examples of the file list display when the availability information is added to an audio file and so on. FIG. 40A shows the example of the file list display for the audio file that can be reproduced, and FIG. 40B shows the example of the file list display fro the audio file that cannot be reproduced. In FIG. 40B, it is observed that an image (mark) indicating that the audio file cannot be reproduced is attached on the icon in FIG. 40A.

Also, the similar image (mark) can be applied to an icon of a file created by an application program required to use certain apparatuses or resources. FIG. 41A shows an example of an icon indicating the availability of the file created by such an application program, and FIG. 41B shows an example of an icon indicating the unavailability of the file created by such an application program. Also, the similar image (mark) can be added to an icon of a data file created by a certain application program. In this case, information indicating whether or not the application program is installed in the computer 1 is obtained from the operating system. If the application program is not installed, the icon to which the unavailability image is attached is displayed. As a result, a user can efficiently find available files in the displayed file list before some operations are performed for the files.

Furthermore, the file display may vary in accordance with the type of connected apparatus. For example, the file display may be changed in accordance with the type of printer such as a monochrome printer and a color printer. If the color printer is provided, a color frame surrounds the thumbnail image of an image file. If the monochrome printer is provided, a monochrome frame surrounds the thumbnail image of an image file. In addition, an estimated printing time may be displayed in accordance with the printing speed of the printer in use.

Furthermore, the above-mentioned file display may be provided not only at the list display time but also when the user selects a file and instructs the computer 1 to print the file. Also, when a scanner is connected to the computer as an input apparatus, an icon for an application program to control the scanner may vary in accordance with the type of the scanner. If the scanner is a color scanner, the icon is displayed as a color icon. If the scanner is a monochrome scanner, the icon is displayed as a monochrome icon.

When a file own operation such as “move”, “delete”, and “copy” is performed for a certain file, the file structure according to the present invention makes it possible to display the availability of the file own operation for a file prior to execution of the file own operation in order to assist the user to operate the file.

In this case, a call program (an operating system or a file name display program) sets the TYPE corresponding to an instruction pertaining to the file own operation and calls the Question function of the management program code. The Question function holds the TYPE corresponding to the instruction pertaining to the file own operation and creates the Q_List corresponding to the TYPE. When the call program obtains the Q_List, the call program creates the A_List corresponding to the Q_List and calls the Answer function. The Answer function obtains the TYPE and uses the A_List to determine whether or not the file operation designated by the TYPE can be performed for the file. If the designated file operation can be performed for the file, the Answer function returns the R_List including the Flag having the value “0”. The call program executes the designated file own operation without any execution of special operations. In this case, as is shown in FIG. 42A, any particular display is not provided for the file.

On the other hand, if the Answer function determines that an alarm should be provided for the designated file own operation, the Answer function returns the R_List containing image data (bitmap image) for indicating the alarm and the Flag having the value “0”. The call program displays the image data for indicating the alarm. For instance, as is shown in FIG. 42B, the alarm image is displayed for the file of interest.

Furthermore, if the designated file is not permitted, the Answer function returns the R_List containing image data for indicating that the file is not permitted and the Flag having the value “0”. The call program displays the image data for indicating that the file is not permitted. For instance, as is shown in FIG. 42C, the denied permission image is displayed for the file of interest.

In the above fashion, when the user instructs the computer 1 to perform a predetermined file own operation such as “move”, “delete” and “copy”, it is possible to display particular images corresponding to the three types of file: the file for which the predetermined file own operation such as “move”, “delete” and “copy” may be performed without any problem, the file that may have some troubles if the predetermined file own operation such as “move”, “delete” and “copy” is performed for the file, and the file that is given no permission to perform the predetermined file own operation such as “move”, “delete” and “copy”. Also, such a file display may be provided when the user selects a file. If the file display is applied in a uniform manner to application programs, library files of the application programs, and files created by the application programs, it is possible to prevent a user from performing an erroneous operation.

A user of the computer 1 is not always a physically unimpaired person. A handicapped person may use the computer 1. Especially, when a visually impaired person operates the computer 1, the visually impaired person is likely to have various troubles. At present, there is a tendency to provide aid functions for such a visually impaired person to a computer system. For instance, there are some functions of increasing the contrast of the display for a person with poor eyesight such as an aged person or enlarging the character font size so that such a visually impaired person can comfortably operates the computer system. In this case, the status of a user is registered in advance to an operating system of the computer system. Then, the operating system sets the display in the high contrast and enlarges the character font size. However, these functions are mainly applied to only characters rather than icons. The icons only represent images corresponding to extensions of files.

A description will now be given of a method for properly aiding a handicapped person. When a user registers the high contrast display and the large font size to the operating system, the management program code obtains the registration information via the operating system and creates icon information for displaying the icon in the high contrast and the large size in accordance with the registration information. In this fashion, the computer system can properly aid the handicapped person.

In detail, the Question function creates the Q_List containing information items pertaining to the registration information such as the contrast arrangement and the font size arrangement. Here, the information items may contain the display area size and the display color size as mentioned above. The operating system finds the registration information and determines whether or not the contrast arrangement and the font size arrangement are registered in the registration information. If the contrast arrangement and the font size arrangement are registered, the operating system adds the information items pertaining to the contrast arrangement and the font size arrangement to the A_List. Also, the operating system may set a larger display area of an icon than the usual display area setting. Then, the operating system calls the Answer function. The Answer function creates icon information in accordance with the A_List and returns the icon information (bitmap image) and the Flag having the value “0” as the R_List to the operating system. The operating system displays an icon based on the icon information in the R_List. Here, the icon size may vary in accordance with the resolution of the display 9 connected to the computer 1.

As is shown in FIG. 17, if information items that the operating system can obtain among the environment information items are prescribed in advance at the development of the operating system, the management program code can obtain the information items held by the operating system via a predetermined interface. In other words, if a table of the environment information items that the operating system can obtain is prepared as shown in FIG. 17, it is possible to easily obtain the environment information items for a file having a format designed or created by an application program distributed after the development of the operating system and flexibly provide information for the file selection and the file operation to the user.

Heretofore, the description has been given of the file selection at the list display time. A description will now be given of the start of an application program.

In general, when a user operates a computer, the user often uses an application program in the computer. The application program usually performs a process for a data file read from the storage apparatus and stores the processed data file in the storage apparatus. A word-processor application program is a typical application program.

When such an application program is used, the user needs to designate the application program and a data file to be processed by the application program for the computer 1. Conventionally, when the user selects a data file to be processed, the operating system automatically starts an application program corresponding to the extension of the data file without the user's operation for starting the application program. As a result, the user selects only the data file in the conventional system. However, the data file is required to have an extension that cannot be changed in the conventional system.

Under the file structure according to the present invention, it is not necessary to fix an extension of a data file created by an application program. When the user selects or reads a file having the file structure according to the present invention, the management program code of the file is designed to call an application program corresponding to the file. Since the application program and the management program code of the file created by using the application program are designed by an identical provider, it is possible to easily call the application program corresponding to the file.

In detail, when a user instructs the computer 1 to read a file created by using a certain application program by double-clicking the file, the operating system sets the TYPE information as reading operation time and calls the Question function in the management program code of the file. The Question function holds the TYPE information and returns the Q_List containing the information items such as installment information of the certain application program and storage location information of the file created by the application program to the operating system. When the operating system obtains the Q_List, the operating system determines whether or not the application program is installed to the computer system. Then, the operating system creates the A_List containing the determination result, together with the storage location if the application program is installed, and calls the Answer function. The Answer function obtains the TYPE information held by the Question function and examines the A_List. If the A_List indicates that the application program is executable, the Answer function directly starts the application program and instructs the application program to read the file. Then, the Answer function returns the Flag having the value “0” to the operating system. If the A_List indicates that the application program is not allowed to start, the Answer function creates a request to start the application program and read the file and then returns the request and the Flag having the value “0” as the R_List to the operating system. When the operating system obtains the R_List, the operating system determines whether or not to the operating system can accommodate the request. If the operating system can accommodate the request, the operating system starts the application program and causes the application program to read the file.

In the above fashion, according to the present invention, it is possible for the operating system to start an application program based on the output information of the management program code rather than an extension of file. Thus, it is possible to start the application program in response to the request to select and read a file without registering the correspondence between extensions and application programs to the operating system.

For instance, regarding the display of HTML (Hyper Text Markup Language) file, if a plurality of browser programs are installed in the computer 1, the extension of the HTML file conventionally corresponds to one of the browser programs and the browser program corresponding to the HTML file automatically starts for the request to read the HTML file. According to the present invention, for instance, when the individual HTML file is created, a user can separately associate the HTML file with a desired browser program. As a result, it is possible to prevent a predetermined browser program from starting uniformly for all HTML files. In addition, even if the extension of the file is altered accidentally, it is possible to start the desired browser program.

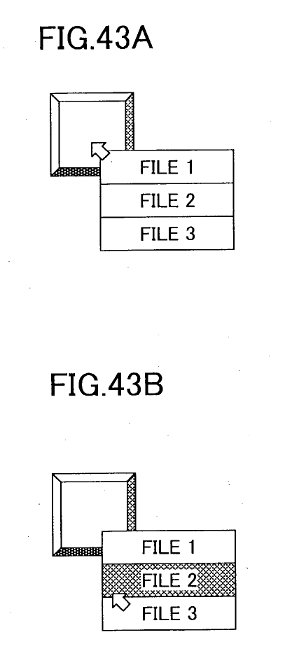

After a user starts an application program, the user may designate a data file to be edited. For this operation, the case in which the file structure according to the present invention is applied to a file of an application program will be described. It is assumed that the application program has a function of maintaining a name record of a plurality of files processed by the application program and currently holds this name record. As is shown in FIG. 43A, in the file structure according to the present invention, when a user selects a file of the application program by using a mouse or the like, the management program code contained in the file of the application program displays a list of files “file 1”, “file 2”, “file 3”, . . . that have been processed before (or immediately before) by means of the application program. As is shown in FIG. 43B, when the user selects one of the files in the list (for example, “file 2”), the management program code starts the application program and instructs the application program to read the selected file.

In this fashion, the user can easily start the application program, select and read the file.

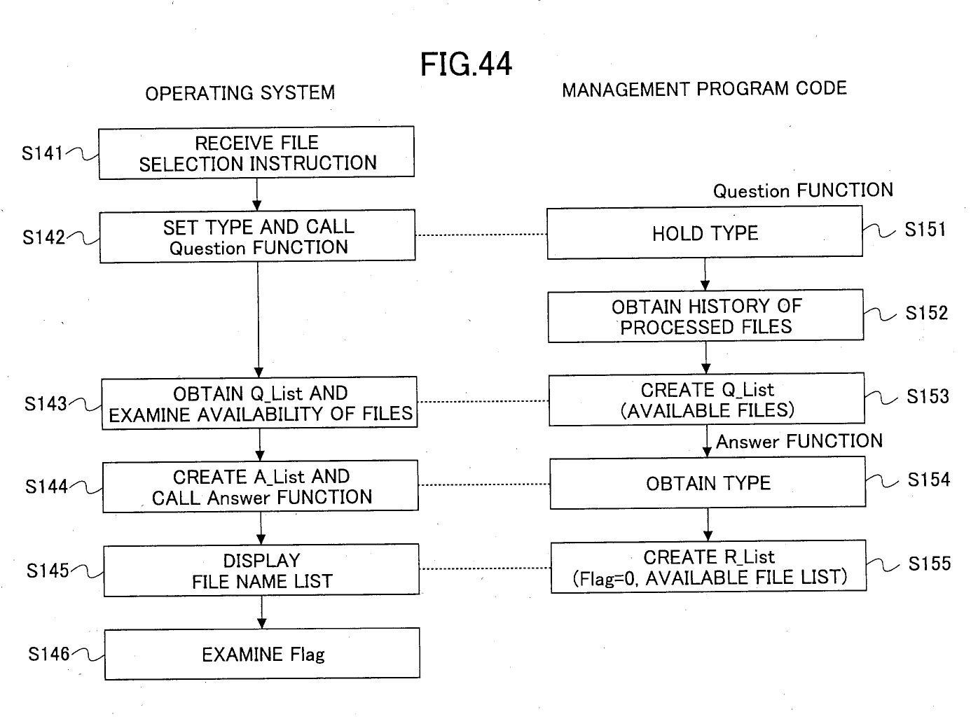

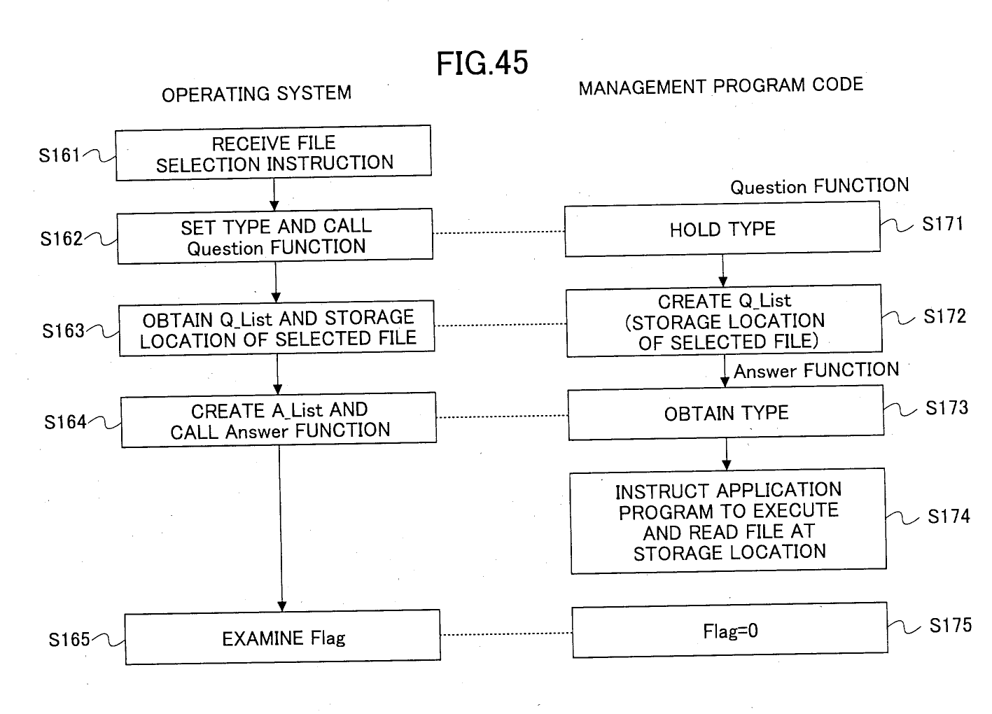

A description will now be given, with reference to flowcharts in FIG. 44 and FIG. 45, of an example of the above-mentioned process. For instance, when the operating system receives a request to select a file of an application program from a user (S141), the operating system sets the TYPE information as the file selection time and calls the Question function of the file (S142). In response to this call, the Question function in the management program code holds the TYPE information (S151). Then, the Question function obtains history information of processed files that are registered in the file (S152) and creates the Q_List indicating the availability of the file (S153).

When the operating system obtains the Q_List, the operating system examines the availability for the individual processed files (S143). Then, the operating system sets the information regarding the availability for the individual processed files as the A_List and calls the Answer function (S144). In response to this call, the Answer function of the management program code obtains the TYPE information from the Question function (S154) and examines the A_List. Then, the Answer function creates the R_List containing a file name list of available files and the Flag having the value “0” and returns the R_List to the operating system (S155). When the operating system obtains the R_List, the operating system displays the file name list in an adjacent location to the icon of the file of the application program as shown in FIG. 43A (S145).

As is shown in FIG. 43B, the user selects a domain of one of the file names in the file name list. When the operating system receives the file selection request (S161), the operating system sets the TYPE information as the file name selection time and calls the Question function (S162). In response to this call, the Question function of the management program code holds the TYPE information (S171) and creates the Q_List containing the storage location information of the selected file (S172). When the operating system obtains the Q_List (S163), the operating system creates the A_List containing the storage location information of the selected file and calls the Answer function (S164). In response to this call, the Answer function of the management program code obtains the TYPE information held by the Question function (S173). Then, the Answer function instructs the application program of the file to start and read the file based on the storage location information contained in the A_List (S174).

Heretofore, the description has been given of the display of file contents as the file operation aiding function. Furthermore, it is possible to perform other aiding functions by using the management program code. For instance, if a notification function informing a file creator of the whereabout of a user via a network is provided to the management program code, the file creator can manage not only the file but also copies of the file. For instance, if such a management program code having the notification function is attached to a file of copyrighted data such as music, the creator of the file, who is an owner of the copyright, is informed whenever a user reproduces the file via the network. As a result, it is possible to develop a billing system for charging for the reproduction based on the notification.

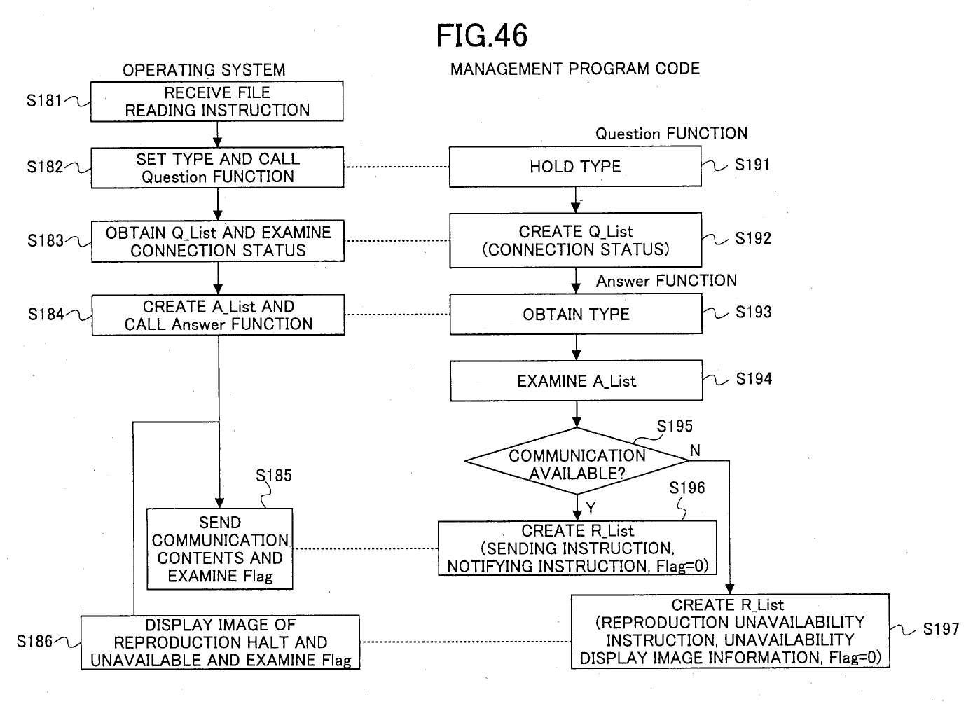

A description will now be given, with reference to a flowchart in FIG. 46, of an example of the above process. When the operating system receives a request to select or read a file from a user (S181), the operating system sets the TYPE information as the file reading or selection and calls the Question function of the management program code in the file (S182). In response to this call, the Question function of the management program code holds the TYPE information (S191) and creates the Q_List containing, for example, information regarding the connection status of a communication apparatus (S192). When the operating system obtains the Q_List, the operating system examines the connection status of the communication apparatus (S183). Then, the operating system creates the A_List containing the information regarding the connection status and calls the Answer function of the management program code (S184). In response to this call, the Answer function of the management program code obtains the TYPE information of the Question function (S193) and determines the connection status of the communication apparatus in the A_List (S194 and S195). If the computer system can communicate (S195: Y), the Answer function creates the R_List containing the notification request and the notification information for the copyright owner and the Flag having the value “0” and returns the R_list to the operating system (S196). When the operating system obtains the R_List, the operating system controls the communication apparatus and sends the notification information to the copyright owner (S185). If permitted by the operating system, the Answer function may instruct the communication apparatus to directly send the notification information to the copyright owner and return the Flag having the value “0” to the operating system. If the computer system cannot communicate (S195: N), the Answer function creates the R_List containing the instruction of giving no permission to reproduce the file, the image information for representing that the file is not allowed to be reproduced, and the Flag having the value “0” and returns the R_List to the operating system (S197). When the operating system obtains the R_List, the operating system confirms the contents of the R_List. In this case, since the R_List contains the instruction of giving no permission to reproduce the file, the operating system stops reading the file contents information of the file and displays the image information in the R_List on the display 9 (S186).

According to the present invention, a file having the novel file structure is provided as shown in FIG. 9 and FIG. 10. The file having the file structure according to the present invention contains a particular management program code related to the file contents information of the file. Also, a uniform interface as shown in FIG. 14 is provided to the management program code. The uniform interface makes it possible for the operating system and the accompanying file name display program to call the management program code in the unified fashion. Furthermore, since the management program code can perform the different operations at the list display time and the file selection time, it is possible to assist a user to select and operate a program file and a data file by alternating the file display in accordance with the user's operation. As a result, it is possible for the user to easily operate the computer 1.

Also, in the above-mentioned examples, the management program code in each file is called based on events caused by the operating system or the accompanying file operation program at the list display time and the file selection time. However, the management program code may operate prior to these events in order to reduce the processing time by calling the management program code for each of the events.

For instance, the management program code of each program obtains computer environment information in advance when the computer starts. When a user selects a file, the management program code may use the computer environment information to perform a process. Also, the task such that the operating system periodically starts individual files may be registered. The task such that the operating system starts the individual files at a predetermined time may be registered.

The primary purpose of the management program code is to improve the operability of files such as the file selection and the file operation for a user. Thus, it is preferable to cause the computer 1 to execute a process when the computer 1 has a small amount of burden. When a program other than the management program code (such as an application program) uses resources of the computer 1, the program may be given the priority of the execution over the management program code.

Additionally, according to the present invention, since the management program code is provided to each file with respect to the file structure, it is possible to commit operations that the operating system and the accompanying programs conventionally serve to perform to the management program code and add functions after the development of the operating system without any dependency on the existing functions of the operating system.

The present invention is not limited to the specifically disclosed embodiments, and variations and modifications may be made without departing from the scope of the present invention.

The present application is based on Japanese priority application No. 2002-003356 filed Jan. 10, 2002, the entire contents of which are hereby incorporated by reference.

What is claimed is:

1. A file creation and display method, comprising the steps of:
receiving an instruction to save file content information formed of a program code or data that a computer executes or processes;
obtaining a management program code prepared in advance by a provider of an application program for processing said file content information, wherein said management program code is called by a program pertaining to an operating system of said computer based on an interface uniformly prescribed for all files in said computer and performs a process for assisting a user of said computer to operate a file in said computer in accordance with file content information of said file;
storing said file content information and said management program code as a file in a storage apparatus;
causing said program pertaining to the operating system to call said management program code of a file to be processed based on said interface uniformly prescribed; and
performing said process for assisting the user of the computer to operate said file in the computer by executing said management program code called by said program pertaining to the operating system.

2. A file creation method, comprising the steps of:
receiving a saving instruction to save file content information formed of a program code or data that a computer executes or processes;
obtaining a management program code prepared in advance by a provider of an application program for processing said file content information, wherein said management program code is called by a program pertaining to an operating system of said computer based on an interface uniformly prescribed for all files in said computer and performs a process for assisting a user of said computer to operate a file in said computer in accordance with file content information of said file; and
storing said file content information and said management program code as a file in a storage apparatus.

3. A file display method, comprising the steps of:
causing a program pertaining to an operating system of a computer to call a management program code of a file to be processed based on an interface uniformly prescribed for all files in said computer, wherein said file stored in a storage apparatus comprises file content information formed of a program code or data that said computer executes or processes and said management program code, and said management program code is prepared in advance by a provider of an application program for processing said file content information and performs a process for assisting a user of said computer to operate a file in said computer in accordance with file content information of said file; and
performing said process for assisting the user of the computer to operate said file in the computer based on said management program code called by said program pertaining to the operating system.

4. A file structure of a file, comprising:
file content information formed of a program code or data that a computer executes or processes; and
a management program code, which is prepared in advance by a provider of an application program for processing said file content information, called by a program pertaining to an operating system of said computer based on an interface uniformly prescribed for all files in said computer and performing a process for assisting a user of said computer to operate a file in said computer in accordance with file content information of said file.

5. The file structure as claimed in claim 4, further comprising a file header containing information indicating that said file has a management program code.

6. The file structure as claimed in claim 4, wherein said management program code performs the process for assisting the user of said computer to operate a file in said computer before the user instructs said computer to execute a program code of file content information of said file or to read data of file content information of said file.

7. The file structure as claimed in claim 4, wherein said management program code is described as an intermediate language code.

8. The file structure as claimed in claim 4, wherein said management program code performs only a certain function allowed by said computer as said process for assisting the user of said computer to operate a file in said computer.

9. The file structure as claimed in claim 4, wherein a point of time when a program pertaining to the operating system starts said management program code of said file is set.

10. The file structure as claimed in claim 4, wherein said management program code has an environment information obtaining part obtaining environment information of said computer and performs said process for assisting the user of said computer to operate a file in said computer with reference to said environment information obtained.

11. The file structure as claimed in claim 10, wherein said environment information of the computer is created based on an information item registered in advance in said computer.

12. The file structure as claimed in claim 10, wherein said management program code determines whether or not the file content information of said file is available and causes said computer to display a determination result of the availability of said file content information.

13. The file structure as claimed in claim 10, wherein said management program code has information, which is registered in advance in said computer, regarding a disability of the user of said computer as the environment information obtained and performs a process corresponding to said information regarding the disability of the user of said computer as the process for assisting the user of said computer to operate a file in said computer.

14. The file structure as claimed in claim 4, wherein said management program code further performs a process for causing said computer to display outline information of file content information as the process for assisting the user of said computer to operate a file in said computer.

15. The file structure as claimed in claim 4, wherein said management program code, when said file content information is audio information, performs a process for causing said computer to reproduce at least a portion of said audio information as the process for assisting the user of said computer to operate a file in said computer.

16. The file structure as claimed in claim 4, wherein said management program code, when said file content information is still image information, performs a process for causing said computer to display one of at least a portion of said still image information and a reduced image of said still image information as the process for assisting the user of said computer to operate a file in said computer.

17. The file structure as claimed in claim 4, wherein said management program code, when said file content information is moving image information, performs a process for causing said computer to reproduce at least a portion of said moving image information as the process for assisting the user of said computer to operate a file in said computer.

18. The file structure as claimed in claim 4, wherein said management program code performs a process different between file list exhibition time when a list of files is displayed and file selection time when a file is selected as the process for assisting the user of said computer to operate a file in said computer.

19. The file structure as claimed in claim 4, wherein said management program code determines whether or not a file own operation is executable for said file and performs a process for causing said computer to display a result of said determination as the process for assisting the user of said computer to operate a file in said computer.

20. The file structure as claimed in claim 4, wherein said file content information contains address information and exhibition image information of a Web page and said management program code performs a process for causing said computer to display outline exhibition image information for showing an outline of said Web page as the process for assisting the user of said computer to operate a file in said computer.

21. The file structure as claimed in claim 20, wherein said management program code, when a Web page is displayed, searches for a file whose file content information contains address information identical to said Web page and updates outline exhibition image information for showing an outline of a Web page of said file when said file is found.

22. The file structure as claimed in claim 4, wherein said management program code, when said file content information is a program code of an application program for displaying or editing a file having a predetermined data format, performs a process for causing said computer to display history list information of said file displayed or edited before by said application program in accordance with an instruction to select said file by the user as the process for assisting the user of said computer to operate a file in said computer.

23. The file structure as claimed in claim 24, wherein said management program code, when the user of said computer selects a file among files that have said predetermined data format and are in said history list information displayed by said computer, performs a process for causing said application program to read said file selected and start as the process for assisting the user of said computer to operate a file in said computer.

24. A program for causing a computer to execute the steps of:
receiving an instruction to save file content information formed of a program code or data that said computer executes or processes;
obtaining a management program code prepared in advance by a provider of an application program for processing said file content information, wherein said management program code is called by a program pertaining to an operating system of said computer based on an interface uniformly prescribed for all files in said computer and performs a process for assisting a user of said computer to operate a file in said computer in accordance with file content information of said file; and
storing said file content information and said management program code as a file in a storage apparatus.

25. The program as claimed in claim 24, wherein said step of receiving the instruction to save the file content information is a step of receiving an instruction to create outline exhibition image information showing an outline of a Web page and said file content information is formed of said outline exhibition image information and address information of said Web page.

26. The program as claimed in claim 25, further causing the computer to execute the steps of: searching for, when a Web page is displayed, a file whose file content information contains address information identical to said Web page; and updating outline exhibition image information for showing an outline of a Web page of said file when said file is found.

27. A program for causing a computer to execute:
preprocessing step of calling a management program code of a file to be processed based on an interface uniformly prescribed for all files in said computer, wherein said file stored in a storage apparatus comprises file content information formed of a program code or data that said computer executes or processes and said management program code, and said management program code is prepared in advance by a provider of an application program for processing said file content information and performs a process for assisting a user of said computer to operate a file in said computer in accordance with file content information of said file and outputting information regarding an operation performed by the user; and
postprocessing step of receiving said information regarding the operation performed by the user from said management program code of said file via said interface and performing a process based on said information.

28. The program as claimed in claim 27, further causing the computer to execute the step of: starting an intermediate language code processing function when said management program code is described as an intermediate language code.

29. The program as claimed in claim 27, further causing the computer to execute the step of: restricting any execution of functions other than a certain function of said management program code.

30. The program as claimed in claim 27, further causing the computer to execute the step of: outputting, when a request to obtain environment information of said computer is received from said management program code, said environment information to said management program code via said interface.

31. The program as claimed in claim 30, further causing the computer to execute the step of: maintaining in advance an environment item to respond to said request to obtain the environment information of said computer.

32. The program as claimed in claim 27, wherein said postprocessing step, when information regarding a determination result of availability of said file content information of said file is received from said management program code, causes said computer to display information regarding said availability.

33. The program as claimed in claim 27, further causing the computer to execute the step of: outputting, when a request to obtain information regarding a disability of the user is received from said management program code, said information regarding the disability registered in advance in said computer to said management program code via said interface.

34. The program as claimed in claim 27, wherein said postprocessing step, when information regarding availability of a file own operation is received from said management program code, causes the computer to display said information regarding the availability of the file own operation.

35. The program as claimed in claim 27, wherein said postprocessing step, when said operation performed by the user is an instruction to read a file, informs a creator of said file that said file is read via a network based on said information from the management program code.

36. The program as claimed in claim 27, wherein said postprocessing step, when outline information of said file content information is received from said management program code, causes the computer to display said outline information.

37. The program as claimed in claim 27, wherein said postprocessing step, when at least a portion of audio information of said file content information is received from said management program code, reproduces said portion of the audio information.

38. The program as claimed in claim 27, wherein said postprocessing step, when at least a portion of still image information or a reduced image of said still image information is received from said management program code, causes the computer to display said portion of said still image information or said reduced image of said still image information.

39. The program as claimed in claim 27, wherein said postprocessing step, when at least a portion of moving image information of said file content information is received from said management program code, reproduces said portion of said moving image information.

40. The program as claimed in claim 27, wherein said postprocessing step causes the computer to display history list information of said file when said file content information of said file is a program code of an application program displaying or editing a file having a predetermined data format and information regarding a file displayed or edited before by said application program is received from said management program code of said file.

41. The program as claimed in claim 27, wherein said preprocessing step outputs said information regarding said operation performed by the user to management program codes of a plurality of files in the computer and said postprocessing step receives said information from said management program codes of said files and performs a process when said operation performed by the user is an instruction to display a list of files.
